(19) United States
(12) Patent Application Publication
(10) Pub. No.: US 2024/0375075 A1
(43) Pub. Date: Nov. 14, 2024

(54) METHODS FOR MAKING FLOW CELLS

(71) Applicant: ILLUMINA, INC., San Diego, CA (US)

(72) Inventors: Francesca Patel-Burrows, Cambridge (GB); Alexandre Richez, Cambourne (GB); Alexandra Szemjonov, Cambridge (GB)

(21) Appl. No.: 18/658,753

(22) Filed: May 8, 2024

Related U.S. Application Data
(60) Provisional application No. 63/501,075, filed on May 9, 2023.

(51) Int. Cl. B01J 19/00

(52) U.S. Cl. CPC B01J 19/0046; B01J 2219/00612; B01J 2219/0063; B01J 2219/00637; B01J 2219/00659

(57) ABSTRACT

In an example of a method of making a flow cell, a functional material is deposited over a resin layer including depressions separated by interstitial regions. The resin layer includes an ultraviolet (UV) light blocking additive. The depressions overlie a first portion of the resin layer having a first thickness, and the interstitial regions overlie a second portion of the resin layer having a second thickness that is greater than the first thickness. The functional material is susceptible to interaction with the resin layer when exposed to UV light. A predetermined UV light dosage is directed through the resin layer, whereby the functional material within the depressions is exposed to the UV light and attaches to the resin layer within the depressions. The functional material overlying the interstitial regions is blocked from being exposed to the UV light by the second resin portion.

### CROSS-REFERENCE TO RELATED APPLICATIONS

This application claims the benefit of U.S. Provisional Application Ser. No. 63/501,075, filed May 9, 2023, the content of which is incorporated by reference herein in its entirety.

### REFERENCE TO SEQUENCE LISTING

The Sequence Listing submitted herewith is hereby incorporated by reference in its entirety. The name of the file is ILI261B_IP-2602-US_Sequence_Listing.xml, the size of the file is 18,612 bytes, and the date of creation of the file is Apr. 30, 2024.

### BACKGROUND

Some available platforms for sequencing nucleic acids and other biomolecules utilize a sequencing-by-synthesis approach. With this approach, a nascent strand is synthesized, and the addition of each monomer (e.g., nucleotide) to the growing strand is detected optically and/or electronically. As a template strand directs synthesis of the nascent strand, one can infer the sequence of the template DNA from the series of nucleotide monomers that were added to the growing strand during the synthesis process. In some examples of sequencing-by-synthesis, sequential paired-end sequencing may be used, where forward strands are sequenced and removed, and then reverse strands are constructed and sequenced. In other examples, simultaneous paired-end sequencing may be used, where forward strands and reverse strands are sequenced at the same time.

### SUMMARY

Examples of the flow cells disclosed herein include a resin layer having depressions defined therein. Individual depressions defined in the resin layer are separated from one another by interstitial regions, and the resin layer has different thicknesses at various portions, e.g., at the depressions and at the interstitial regions. The resin layer may further include an ultraviolet (UV) light blocking additive that is capable of reflecting and/or absorbing UV light radiation. By manipulating the resin layer (e.g., composition and/or thickness) and with the UV light blocking additive included therein, the initiation of UV-triggered chemical reactions at the resin layer surface may be controlled. As such, the methods described herein enable UV-triggered reactions to occur at targeted and desirable areas of the resin layer. Controlling the initiation of UV-triggered reactions can prevent materials from attaching to undesired areas of the resin layer surface, and thus can eliminate additional process steps during manufacturing, such as polishing such materials away from the undesired areas. Thus, the various methods described herein simplify flow cell manufacturing workflows and facilitate the selective initiation of UV-triggered reactions at various portions of the resin layer surface.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1A is a top view of an example of a flow cell;

FIG. 1B is an enlarged, and partially cutaway view of an example of an architecture within a flow channel of the flow cell;

FIG. 1C is an enlarged, and partially cutaway view of another example of the architecture within a flow channel of the flow cell;

FIG. 2A through FIG. 2D are schematic views that together illustrate one example of a method disclosed herein, where FIG. 2A depicts the formation of a depression, in a resin layer, that is directly adjacent to interstitial regions, FIG. 2B depicts the application of a functional material (that is susceptible to interaction with the resin layer when exposed to UV light) over the resin layer that defines the depression and the interstitial regions, FIG. 2C depicts the exposure of the structure of FIG. 2B to a predetermined UV light dosage and the formation of attached functional material within the depression, and FIG. 2D depicts the removal of unattached functional material from the interstitial regions;

FIG. 3A through FIG. 3C are schematic views that together illustrate an example of another method disclosed herein, where FIG. 3A depicts the introduction of a functional material into a flow cell including two patterned substrates, each patterned substrate including a resin layer having depressions that are separated by interstitial regions defined therein, FIG. 3B depicts the exposure of each of the two patterned substrates to a predetermined UV light dosage and the formation of attached functional material within the depressions of each of the two patterned substrates, and FIG. 3C depicts the removal of unattached functional material from the interstitial regions of each of the two patterned substrates;

FIG. 4A through FIG. 4E are schematic views that together illustrate an example of yet another method disclosed herein, where FIG. 4A depicts the application of a first functional material over a resin layer having a depression defined therein that is directly adjacent to interstitial regions, FIG. 4B depicts the exposure of the structure of FIG. 4A to a predetermined UV light dosage and the formation of attached first functional material within the depression, FIG. 4C depicts the removal of unattached first functional material from the interstitial regions, FIG. 4D depicts the application of a second material over the interstitial regions and over the attached first functional material within the depression, and FIG. 4E depicts the direct exposure of the second material to a second predetermined UV light dosage and the formation of attached second material over the interstitial regions;

FIG. 5A is a graphical representation, in terms of absorbance (arbitrary units, Y axis) versus wavelength (nm, X axis), of the results of spectrophotometry tests that demonstrate the absorptive effect(s) of an inorganic UV light blocking additive included in different example resin layers;

FIG. 5B is a graphical representation, in terms of absorbance (arbitrary units, Y axis) versus wavelength (nm, X axis), of the results of spectrophotometry tests that demonstrate the absorptive effect(s) of an organic UV light blocking additive included in different example resin layers;

FIG. 6A is a graphical representation, in terms of absorbance (arbitrary units, Y axis) versus wavelength (nm, X axis), of the results of spectrophotometry tests that demonstrate the effect(s) of varying resin layer thickness on UV light transmittance (and absorption) through examples of the resin layer(s) described herein which contained an example of the organic UV light blocking additive;

FIG. 6B is a further graphical representation, in terms of absorbance (arbitrary units, Y axis) versus resin thickness (nm, X axis), of the results of the spectrophotometry tests that demonstrate the effect(s) of varying resin layer thickness on UV light transmittance (and absorption) through examples of the resin layer(s) described herein which contained an example of the organic UV light blocking additive;

FIG. 7A is a schematic view of an example of primer sets that can be used in an example of one of the flow cells disclosed herein; and

FIG. 7B is a schematic view of another example of primer sets that can be used in an example of one of the flow cells disclosed herein.

### DETAILED DESCRIPTION

Examples of the flow cells disclosed herein may be used for sequencing processes, examples of which include sequential paired-end nucleic acid sequencing. During an example of sequential paired-end sequencing, a primer set is attached within a depression that is defined in a resin layer of a flow cell. The primers in the primer set include orthogonal cleaving (linearization) chemistry that enables forward strands to be generated, sequenced, and then removed, and then enables reverse strands to be generated, sequenced, and then removed. In these examples, orthogonal cleaving chemistry means that a first cleavage site is not susceptible to the removal mechanism for a second cleavage site, and vice versa. As such, orthogonal cleaving chemistry may be realized through different cleavage sites that are attached to the different primers in the set.

Other examples of the flow cells disclosed herein may be used for simultaneous paired-end nucleic acid sequencing. For simultaneous paired-end sequencing, different primer sets are attached to different regions of a patterned substrate (e.g., one primer set may be attached within depressions and another primer set may be attached over interstitial regions, both the two sets may be respectively attached at different regions within the depressions). In these examples, the primer sets may be controlled so that the cleaving (linearization) chemistry is orthogonal in the different regions. In these examples, orthogonal cleaving chemistry may be realized through identical cleavage sites that are attached to different primers in the different sets, or through different cleavage sites that are attached to different primers in the different sets. This enables a cluster of forward strands to be generated in one region (e.g., in the depression) and a cluster of reverse strands to be generated in another region (e.g., interstitials adjacent the depression). In any of these examples, the forward and reverse strands are spatially separate, which separates the fluorescence signals from both reads while allowing for simultaneous base calling of each read.

Several example methods are described to generate the various examples of the flow cells.

### Definitions

It is to be understood that terms used herein will take on their ordinary meaning in the relevant art unless specified otherwise. Several terms used herein and their meanings are set forth below.

An “acrylamide monomer” is a monomer with the structure

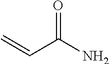

or a monomer including an acrylamide group. Examples of the monomer including an acrylamide group include azido acetamido pentyl acrylamide:

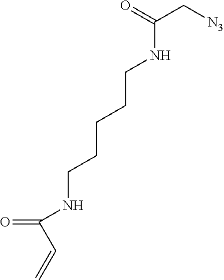 [SMILES: C=CC(=O)NCCCCCNC(=O)CN=[N+]=[N-]]

### and N-isopropylacrylamide:

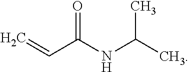

Other acrylamide monomers may be used.

An “aldehyde,” as used herein, is an organic compound containing a functional group with the structure —CHO, which includes a carbonyl center (i.e., a carbon double-bonded to oxygen) with the carbon atom also bonded to hydrogen and an R group, such as an alkyl or other side chain. The general structure of an aldehyde is:

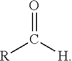

As used herein, “alkenyl” refers to a straight or branched hydrocarbon chain containing one or more double bonds. The alkenyl group may have 2 to 20 carbon atoms. Example alkenyl groups include ethenyl, propenyl, butenyl, pentenyl, hexenyl, and the like.

As used herein, “alkyl” refers to a straight or branched hydrocarbon chain that is fully saturated (i.e., contains no double or triple bonds). The alkyl group may have 1 to 20 carbon atoms. Example alkyl groups include methyl, ethyl, propyl, isopropyl, butyl, isobutyl, tertiary butyl, pentyl, hexyl, and the like. As an example, the designation “C1-4 alkyl” indicates that there are one to four carbon atoms in the alkyl chain, i.e., the alkyl chain is selected from the group consisting of methyl, ethyl, propyl, isopropyl, n-butyl, isobutyl, sec-butyl, and t-butyl.

As used herein, “alkyne” or “alkynyl” refers to a straight or branched hydrocarbon chain containing one or more triple bonds. The alkynyl group may have 2 to 20 carbon atoms.

An “amine” or “amino” functional group refers to an —NRₐR_{b} group, where Rₐ and R_{b} are each independently selected from hydrogen (e.g.,

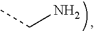

C1-6 alkyl, C2-6 alkenyl, C2-6 alkynyl, C3-7 carbocycle, C6-10 aryl, 5-10 membered heteroaryl, and 5-10 membered heterocyclyl, as defined herein.

As used herein, “aryl” refers to an aromatic ring or ring system (i.e., two or more fused rings that share two adjacent carbon atoms) containing only carbon in the ring backbone. When the aryl is a ring system, every ring in the system is aromatic. The aryl group may have 6 to 18 carbon atoms. Examples of aryl groups include phenyl, naphthyl, azulenyl, and anthracenyl.

As used herein, the term “attached” refers to the state of two things being joined, fastened, adhered, connected or bound to each other, either directly or indirectly. For example, a functional material (e.g., a polymeric hydrogel, an oligonucleotide primer, etc.) can be attached to a target surface (e.g., of a resin layer) by a covalent or non-covalent bond. A covalent bond is characterized by the sharing of pairs of electrons between atoms. A non-covalent bond is a physical bond that does not involve the sharing of pairs of electrons and can include, for example, hydrogen bonds, ionic bonds, Van der Waals forces, hydrophilic interactions and hydrophobic interactions. In some examples described herein, attachment may be facilitated by a UV light triggered reaction.

The term “azirine” refers to a three-membered heterocyclic unsaturated compound containing a nitrogen atom.

An “azide” or “azido” functional group refers to —N₃.

The term “base support,” as used herein, refers to a material upon which another material or material layer (e.g., resin layer) may be introduced.

As used herein, a “bonding region” refers to an area of a patterned substrate that is to be bonded to another material, which may be, as examples, a lid, a patterned substrate, etc., or combinations thereof (e.g., a patterned substrate and a lid). The bond that is formed at the bonding region may be a chemical bond (as described above in regard to attachment), or a mechanical bond (e.g., using a fastener, etc.).

As used herein, “carbocycle” means a non-aromatic cyclic ring or ring system containing only carbon atoms in the ring system backbone. When the carbocycle is a ring system, two or more rings may be joined together in a fused, bridged or spiro-connected fashion. Carbocycles may have any degree of saturation, provided that at least one ring in a ring system is not aromatic. Thus, carbocycles include cycloalkyls, cycloalkenyls, and cycloalkynyls. The carbocycle group may have 3 to 20 carbon atoms. Examples of carbocycle rings include cyclopropyl, cyclobutyl, cyclopentyl, cyclohexyl, cyclohexenyl, 2,3-dihydro-indene, bicyclo [2.2.2]octanyl, adamantyl, and spiro [4.4]nonanyl.

As used herein, the terms “carboxylic acid” or “carboxyl” as used herein refer to

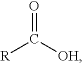

where R is an alkyl group, an alkenyl group, an aryl group, or another substituent.

As used herein, “cycloalkylene” means a fully saturated carbocycle ring or ring system that is attached to the rest of the molecule via two points of attachment.

As used herein, “cycloalkenyl” or “cycloalkene” means a carbocycle ring or ring system having at least one double bond, wherein no ring in the ring system is aromatic. Examples include cyclohexenyl or cyclohexene and norbornenyl or norbornene. Also as used herein, “heterocycloalkenyl” or “heterocycloalkene” means a carbocycle ring or ring system with at least one heteroatom in ring backbone, having at least one double bond, wherein no ring in the ring system is aromatic.

As used herein, “cycloalkynyl” or “cycloalkyne” means a carbocycle ring or ring system having at least one triple bond, wherein no ring in the ring system is aromatic. An example is cyclooctyne. Another example is bicyclononyne. Also as used herein, “heterocycloalkynyl” or “heterocycloalkyne” means a carbocycle ring or ring system with at least one heteroatom in ring backbone, having at least one triple bond, wherein no ring in the ring system is aromatic.

The term “depositing,” as used herein, refers to any suitable application technique, which may be manual or automated, and, in some instances, results in modification of surface properties. Generally, depositing may be performed using vapor deposition techniques, coating techniques, grafting techniques, or the like. Some specific examples include spray coating (e.g., ultrasonic spray coating), spin coating, dunk or dip coating, doctor blade coating, puddle dispensing, flow through coating, aerosol printing, screen printing, microcontact printing, inkjet printing, or the like.

As used herein, the term “depression” refers to a discrete concave feature in a patterned substrate having a surface opening. The depression may be at least partially surrounded by interstitial region(s) of the patterned substrate. Depressions can have any of a variety of shapes at their opening in a surface including, as examples, round, elliptical, square, polygonal, star shaped (with any number of vertices), etc. The cross-section of a depression taken orthogonally with the surface can be curved, square, polygonal, hyperbolic, conical, angular, etc. As an example, the depression may be a well or two interconnected wells. The depression may also have more complex architectures, such as ridges, step features, etc.

“Dibenzoyl,” as used herein, refers to a compound including two benzoyl groups (e.g., two benzene or phenyl rings, each independently bonded to a separate carbonyl group).

The term “each,” when used in reference to a collection of items, is intended to identify an individual item in the collection, but does not necessarily refer to every item in the collection. Exceptions can occur if explicit disclosure or context clearly dictates otherwise.

As used herein, the term “flow cell” is intended to mean a vessel having a flow channel where a reaction can be carried out, an inlet for delivering reagent(s) to the flow channel, and an outlet for removing reagent(s) from the flow channel. In some examples, the flow cell also enables the detection of the reaction that occurs in the flow cell. For example, the flow cell can include one or more transparent surfaces allowing for the optical detection of arrays, optically labeled molecules, or the like.

As used herein, a “flow channel” or “channel” may be an area defined between two bonded components, which can selectively receive a liquid sample. In some examples, the flow channel may be defined between a patterned substrate and a lid, and thus may be in fluid communication with one or more surface chemistries on the patterned substrate. In other examples, the flow channel may be defined between two patterned substrates (each of which has surface chemistry thereon), and thus may be in fluid communication with the surface chemistry of both of the substrates.

As used herein, a “functional material” or a “first functional material” refers to a material (e.g., a polymeric hydrogel in the form of a layer or a particle, or a polymeric hydrogel that is coated on a core particle, or a primer of a primer set) that is susceptible to a particular chemical reaction (e.g., chemical bonding with a resin layer or with another substance) when exposed to UV light. After exposure to UV light, the functional material undergoes a UV-triggered chemical reaction with the underlying resin layer so that the two become attached. Following this chemical reaction, the functional material is referred to as the “attached functional material.”

As used herein, “heteroaryl” refers to an aromatic ring or ring system (i.e., two or more fused rings that share two adjacent atoms) that contain(s) one or more heteroatoms, that is, an element other than carbon, such as nitrogen, oxygen, and/or sulfur, in the ring backbone. When the heteroaryl is a ring system, every ring in the system is aromatic. The heteroaryl group may have 5-18 ring members.

As used herein, “heterocycle” means a non-aromatic cyclic ring or ring system containing at least one heteroatom in the ring backbone. Heterocycles may be joined together in a fused, bridged or spiro-connected fashion. Heterocycles may have any degree of saturation provided that at least one ring in the ring system is not aromatic. In the ring system, the heteroatom(s) may be present in either a non-aromatic or aromatic ring. The heterocycle group may have 3 to 20 ring members (i.e., the number of atoms making up the ring backbone, including carbon atoms and heteroatoms). In some examples, the heteroatom(s) are O, N, or S.

The term “hydrazine” or “hydrazinyl” as used herein refers to a —NHNH₂ group.

As used herein, the term “hydrazone” or “hydrazonyl” refers to a

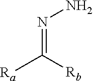

group in which Rₐ and R_{b} are each independently selected from hydrogen, C1-6 alkyl, C2-6 alkenyl, C2-6 alkynyl, C3-7 carbocycle, C6-10 aryl, 5-10 membered heteroaryl, and 5-10 membered heterocycle, as defined herein.

As used herein, “hydroxy” or “hydroxyl” refers to an —OH group.

“Nitrile oxide,” as used herein, means a “RₐC≡N+O” group in which Rₐ is defined herein. Examples of preparing nitrile oxide include in situ generation from aldoximes by treatment with chloramide-T or through action of a base on imidoyl chlorides [RC(Cl)═NOH] or from the reaction between hydroxylamine and an aldehyde.

“Nitrone,” as used herein, means a

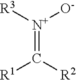

group in which R¹, R², and R³ may be any of the Rₐ and R_{b} groups defined herein, except that R³ is not hydrogen (H).

As used herein, a “nucleotide” includes a nitrogen containing heterocyclic base, a sugar, and one or more phosphate groups. Nucleotides are monomeric units of a nucleic acid sequence. In RNA, the sugar is a ribose, and in DNA, the sugar is a deoxyribose, i.e. a sugar lacking a hydroxyl group that is present at the 2′ position in ribose. The nitrogen containing heterocyclic base (i.e., nucleobase) can be a purine base or a pyrimidine base. Purine bases include adenine (A) and guanine (G), and modified derivatives or analogs thereof. Pyrimidine bases include cytosine (C), thymine (T), and uracil (U), and modified derivatives or analogs thereof. The C-1 atom of deoxyribose is bonded to the N-1 atom of a pyrimidine or to the N-9 atom of a purine. A nucleic acid analog may have any of the phosphate backbone, the sugar, or the nucleobase altered. Examples of nucleic acid analogs include, for example, universal bases or phosphate-sugar backbone analogs, such as peptide nucleic acid (PNA).

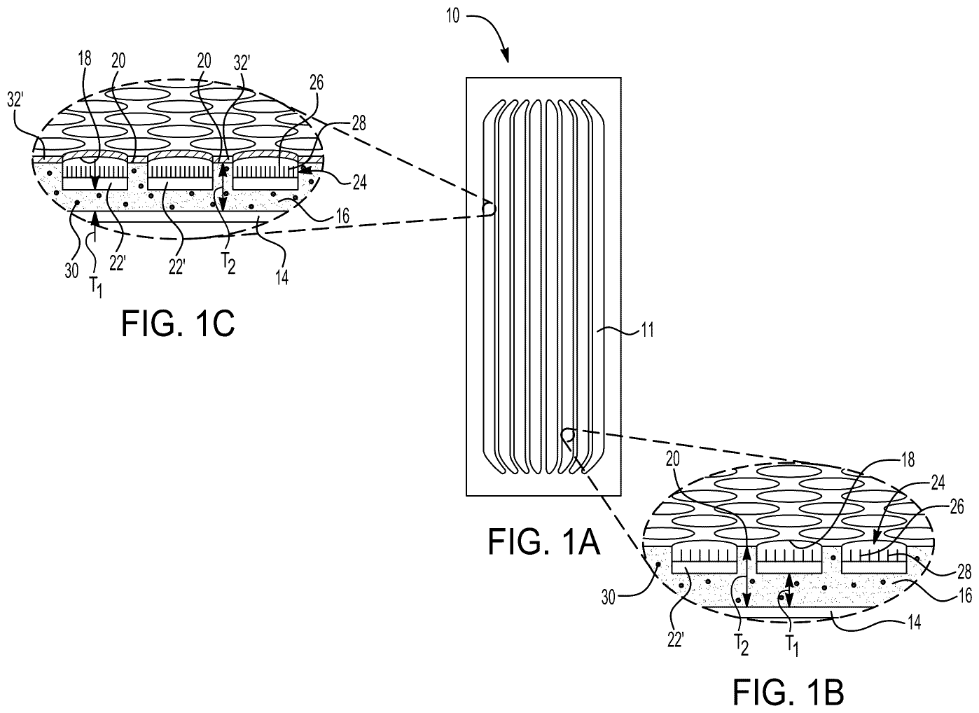

In some examples, the term “over” may mean that one component or material is positioned directly on another component or material. When one is directly on another, the two are in contact with each other. For example, in FIG. 1B, a resin layer 16 is applied over a base support 14, so that the resin layer 16 is directly on and in contact with the base support 14.

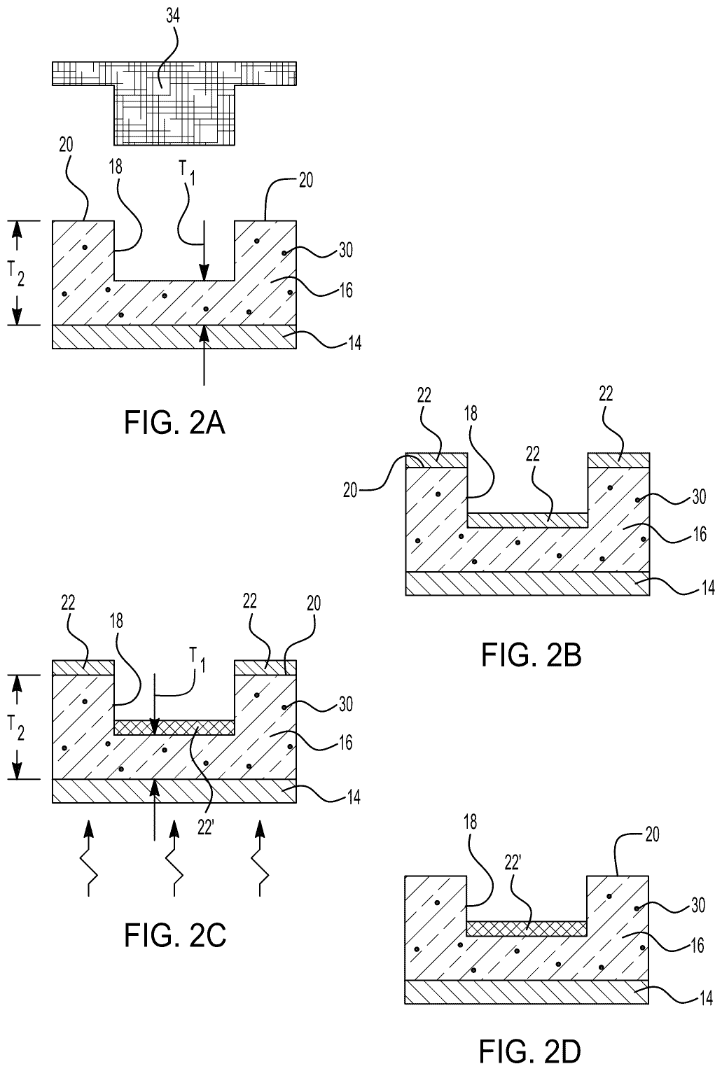

In other examples, the term “over” may mean that one component or material is positioned indirectly on another component or material. By indirectly on, it is meant that a gap or an additional component or material is positioned between the two components or materials. For example, in FIG. 2B, a functional material 22 is positioned over the base support 14, such that the two are in indirect contact. The resin layer 16 is positioned therebetween.

A “patterned substrate” or “patterned structure” refers to a structure including a resin layer applied, in some instances, over a base support, where the resin layer has depressions defined therein in a pattern. In some instances, surface chemistry is introduced into the depressions. In some examples, the structure has been exposed to patterning techniques (e.g., stamping, etching, lithography, etc.) in order to generate the patterns/architectures for the depressions. The patterned substrate may be generated via any of the methods disclosed hereinbelow.

As used herein, in some examples, a “pre-clustered particle” includes a core, a hydrogel coating attached to the core, a plurality of primers attached to side chains or arms of the hydrogel coating, a plurality of amplicons attached to at least some of the plurality of primers, and a surface attachment mechanism to attach the pre-clustered particle to a resin layer. In other instances, the core of the pre-clustered particle is made of the polymeric hydrogel, and thus an additional polymeric hydrogel coating is not included.

As used herein, a “primer” is defined as a single stranded nucleic acid sequence (e.g., single strand DNA). Some primers, referred to herein as amplification primers, serve as a starting point for template amplification and cluster generation. Other primers, referred to herein as sequencing primers, serve as a starting point for DNA synthesis. The 5′ terminus of the primer may be modified to allow a coupling reaction with a functional group of a polymer. The primer length can be any number of bases long and can include a variety of non-natural nucleotides. In an example, the sequencing primer is a short strand, ranging from 10 to 60 bases, or from 20 to 40 bases.

“Surface chemistry,” as used herein, refers to i) primers that are, or are to be, attached to a flow cell surface and that are capable of amplifying a library template strand, or ii) the primers, and the polymeric hydrogel that attaches the primers to a substrate.

The term “sydnone” refers to a mesoionic heterocyclic chemical compound possessing a 1,2,3-oxadiazole core with a keto group in the 5 position. A “thiol” functional group refers to —SH.

As used herein, the terms “tetrazine” and “tetrazinyl” refer to six-membered heteroaryl group comprising four nitrogen atoms. Tetrazine can be optionally substituted.

“Tetrazole,” as used herein, refers to a five-membered heterocyclic group including four nitrogen atoms. Tetrazole can be optionally substituted.

The term “UV blocking” may be used to describe a material that is capable of at least partially absorbing and/or reflecting a particular wavelength or range of wavelengths. Transmittance, which is the ratio of light energy falling on a body to that transmitted through the body, may be used to quantity the UV blocking characteristics of the material. In the examples disclosed herein, the transmittance of a material that is capable of blocking UV light may range from 0 (0%) to less than 0.25 (25%). In instances where the transmittance of the material that is capable of blocking UV light is greater than about 0.1 (10%), it may be desirable to include UV-transmitting portions (e.g., thinner portions) and UV-blocking portions (e.g., thicker portions) that result in a higher UV-blocking contrast, i.e., a higher difference in UV blocking capability. As one example, the transmittance of the UV-transmitting portions may be selected to have a transmittance of 0.85 (85%) or higher when the transmittance of the UV-blocking portions ranges from 0.1 to 0.25.

The term “UV transmitting” or “UV transmittent” may be used to describe a material that is capable of allowing a particular ultraviolet light wavelength or range of wavelengths to pass therethrough. The transmittance of a base support or a resin layer will depend upon the thickness of the base support or layer, the presence, type, and amount of any UV light blocking additive, the wavelength of light, and the dosage of the light to which the base support or the resin layer is exposed. In the examples disclosed herein, the transmittance of the base support or the thinner portions of the resin layer may range from 0.25 (25%) to 1 (100%).

“Triazine,” as used herein, refers to a six-membered heterocyclic group including three nitrogen atoms and three carbon atoms. Triazine can be optionally substituted.

The singular forms “a”, “an”, and “the” include plural referents unless the context clearly dictates otherwise.

The terms comprising, including, containing and various forms of these terms are synonymous with each other and are meant to be equally broad.

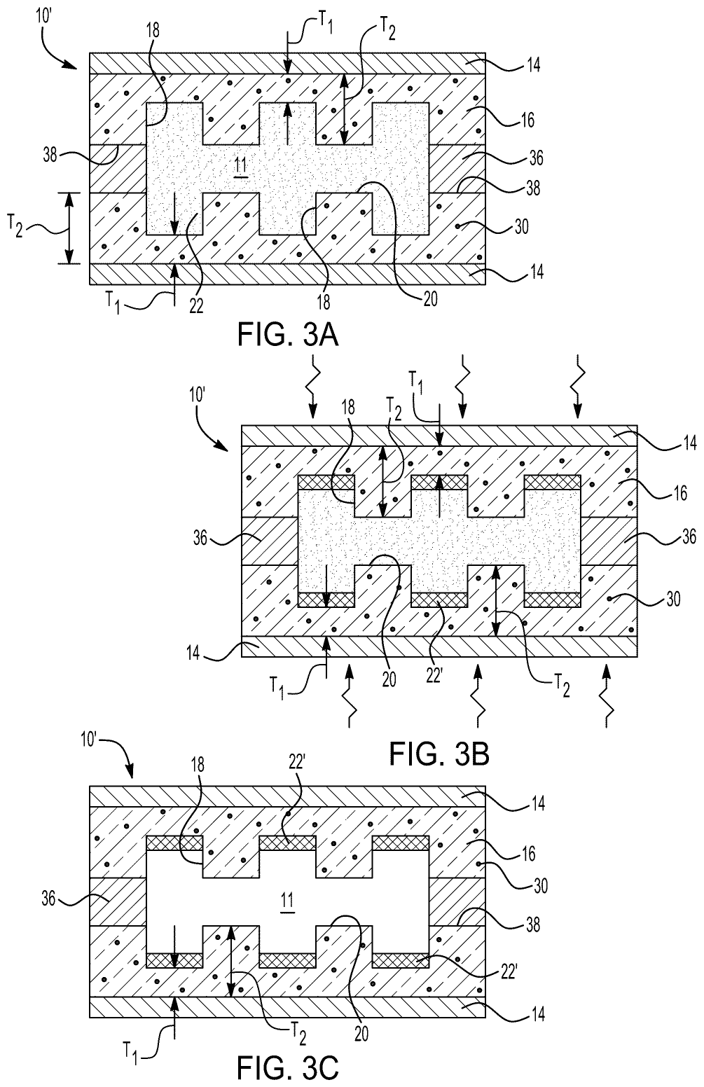

The terms top, bottom, lower, upper, on, overlie, etc. are used herein to describe the flow cell and/or the various components of the flow cell. It is to be understood that these directional terms are not meant to imply a specific orientation, but are used to designate relative orientation between components. The use of directional terms should not be interpreted to limit the examples disclosed herein to any specific orientation(s). As an example, the flow cell in FIG. 3A includes two patterned structures, the depressions of which face a flow channel defined therebetween. In the lower patterned structure, the thinner portion of the resin layer underlies each of the depressions, and in the upper patterned structure, the thinner portion of the resin layer overlies each of the depressions. However, the flow cell may be inverted such that the opposite is true. Thus, whether one component overlies or underlies another component may depend upon the orientation of the components being described.

The terms first, second, etc. also are not meant to imply a specific orientation or order, but rather are used to distinguish one component from another.

It is to be understood that the ranges provided herein include the stated range and any value or sub-range within the stated range, as if such values or sub-ranges were explicitly recited. For example, a range of about 400 nm to about 1 μm (1000 nm), should be interpreted to include not only the explicitly recited limits of about 400 nm to about 1 μm, but also to include individual values, such as about 708 nm, about 945.5 nm, etc., and sub-ranges, such as from about 425 nm to about 825 nm, from about 550 nm to about 940 nm, etc. Furthermore, when “about” and/or “substantially” are/is utilized to describe a value, the term(s) are/is meant to encompass minor variations (up to +/−10%) from the stated value.

### Flow Cells

An example of a flow cell for sequential paired-end sequencing generally comprises a patterned structure including a resin layer having depressions defined therein, and a functional material attached within the depressions.

One example of the flow cell 10 is shown in FIG. 1A from a top view. While not shown in the figure, the flow cell 10 may include two patterned structures bonded together (as is described in reference to the method depicted in FIG. 3A through FIG. 3C) or one patterned structure bonded to a lid (the latter of which is not shown).

Between the two patterned structures or the one patterned structure and the lid is a flow channel 11. The two patterned structures or the one patterned structure and the lid may be bonded together via a spacer layer (see reference numeral 36 in FIG. 3A through FIG. 3C). Thus, each flow channel 11 is defined by the patterned structure, the spacer layer, and either the lid or the second patterned structure.

The example shown in FIG. 1A includes eight flow channels 11. While eight flow channels 11 are shown in the figure, it is to be understood that any number of flow channels 11 may be included in the flow cell 10 (e.g., a single flow channel 11, four flow channels 11, etc.). Each flow channel 11 may be isolated from another flow channel 11 so that fluid introduced into a flow channel 11 does not flow into adjacent flow channel(s) 11. Some examples of the fluids introduced into the flow channel 11 may introduce reaction components (e.g., DNA sample, polymerases, sequencing primers, nucleotides, etc.), washing solutions, deblocking agents, etc.

Each flow channel 11 is in fluid communication with an inlet and an outlet (not shown). The inlet and outlet of each flow channel 11 may be positioned at opposed ends of the flow cell 10. The inlets and outlets of the respective flow channels 11 may alternatively be positioned anywhere along the length and width of the flow channel 11 that enables desirable fluid flow.

The inlet allows fluids to be introduced into the flow channel 11, and the outlet allows fluid to be extracted from the flow channel 11. Each of the inlets and outlets is fluidly connected to a fluidic control system (including, e.g., reservoirs, pumps, valves, waste containers, and the like) which controls fluid introduction and expulsion.

The flow channel 11 may have any desirable shape. In an example, the flow channel 11 has a substantially rectangular configuration with curved ends (as shown in FIG. 1A). The length of the flow channel 11 depends, in part, upon the size of the substrate (e.g., the resin layer and the base support) used to form the patterned structure. The width of the flow channel 11 depends, in part, upon the size of the substrate used to form the patterned structure, the desired number of flow channels 11, the desired space between adjacent channels 11, and the desired space at a perimeter of the patterned structure. The spaces between channels 11 and at the perimeter may be sufficient for attachment to a lid (or another patterned structure.

The depth of the flow channel 11 can be as small as a monolayer thick when microcontact, aerosol, or inkjet printing is used to deposit a separate material that defines the flow channel 11 walls. This separate material is one example of the spacer layer 36. For other examples, the depth of the flow channel 11 can be about 1 μm, about 10 μm, about 50 μm, about 100 μm, or more. In an example, the depth may range from about 10 μm to about 100 μm. In another example, the depth may range from about 10 μm to about 30 μm. In still another example, the depth is about 5 μm or less. It is to be understood that the depth of the flow channel 11 may be greater than, less than or between the values specified above.

The spacer layer (again, see reference numeral 36 in FIG. 3A through FIG. 3C) used to attach the patterned structure and the lid (or used to attach a first patterned structure and a second patterned structure) may be any material that will seal portions of the patterned structure and the lid (or that will seal portions of the first patterned structure and the second patterned structure). As examples, the spacer layer 36 may be an adhesive, a radiation-absorbing material that aids in bonding, or the like. In some examples, the spacer layer 36 is the radiation-absorbing material, e.g., KAPTON® black.

When used, the lid may be any material that is transparent to the excitation light that is directed toward the flow cell 10 during a sequencing operation. In optical detection systems, the lid may also be transparent to the emissions generated from reaction(s) taking place in the flow cell 10. As examples, the lid may include glass (e.g., borosilicate, fused silica, etc.) or a transparent polymer. A commercially available example of a suitable borosilicate glass is D 263®, available from Schott North America Inc. Commercially available examples of suitable polymer materials, namely cyclo olefin polymers, are the ZEONOR® products available from Zeon Chemicals L.P. In some instances, the lid is shaped to form the top of the flow cell 10, and in other instances, the lid is shaped to form both the top of the flow cell 10 as well as sidewalls the flow channel 11.

The patterned structure includes a bonding region where it can be sealed to the lid or to the second patterned structure. The bonding region may be located at the perimeter of each flow channel 11 and/or at the perimeter of the patterned structure (and thus at the perimeter of the flow cell 10).

As shown in FIG. 1B and FIG. 1C, the flow channel 11 is at least partially defined by a resin layer 16 of at least one patterned structure. The patterned structure includes the resin layer 16 having depressions 18 defined therein, where the depressions 18 are separated by interstitial regions 20. As further shown in FIG. 1B and FIG. 1C, the resin layer 16 is applied directly over a base support 14.

Suitable example materials for the base support 14 are capable of transmitting a predetermined UV light dosage that is used to initiate a chemical reaction within the depressions 18 that are defined in the resin layer 16 (as is described in more detail herein). The base support 14 that is selected is also transparent to the excitation light that is directed toward the flow cell 10 during a sequencing operation. As some examples, the base support 14 may include siloxanes, glass, modified or functionalized glass, polymeric materials (including acrylics, polystyrene and copolymers of styrene and other materials, polyethylene terephthalate (PET), polycarbonate, cyclic olefin copolymer (COC), some polyamides), silica or silicon oxide (e.g., SiO₂), fused silica, silica-based materials, silicon nitride (Si₃N₄), resins, or the like. The material of the base support 14 may be a pure material, a material with some impurities, or a mixture of materials, as long as the resulting base support 14 is capable of the desired transmittance.

The base support 14 may be a circular sheet, a panel, a wafer, a die, etc. having a diameter ranging from about 2 mm to about 300 mm, e.g., from about 200 mm to about 300 mm, or may be a rectangular sheet, panel, wafer, die etc. having its largest dimension up to about 10 feet (˜3 meters). For example, a die may have a width ranging from about 0.1 mm to about 10 mm. While example dimensions have been provided, it is to be understood that a base support 14 with any suitable dimensions to support the resin layer 16 may be used.

As described, the patterned substrate includes the resin layer 16. The resin layer 16 has depressions 18 defined therein, and has interstitial regions 20 that separate the depressions 18. The material of the resin layer 16 may exhibit variable transmittance depending, in part, upon the thickness of the resin layer 16. In the examples set forth herein, the material of the resin layer 16 is selected to be capable of transmitting the predetermined UV light dosage through portions underlying the depressions 18 (as is described in more detail herein). Examples of materials for the resin layer 16 that can transmit UV light include polymeric resins, such as a poly(ethylene glycol) resin, a polyether resin (e.g., ring opened epoxies), an acrylic resin, an acrylate resin, a methacrylate resin, a thiol-based resin, a tetrazole-based resin, an amorphous fluoropolymer resin (e.g., CYTOP® from Bellex), and combinations thereof. Other example resins include sydnone-containing polymers, azirine-containing polymers, resins capable of oxime ligation (e.g., those including electrophilic carbonyl group(s) (e.g., aldehyde/ketone) that can react with a nucleophilic aminooxy group), or any other resin containing a UV-clickable functional group.

Any of the example resin materials set forth herein also include surface functional groups that are capable of reacting (upon exposure to UV light) with functional groups of the functional material 22′ (or in some instances, of the second material 32′ shown in FIG. 1C) that is to be attached to the resin layer 16 during the example methods. As one example, a thiol-ene resin (made of acrylate and thiol monomers) includes surface thiol groups that can react with alkenes or alkynes of the functional material 22′ (or alkenes/alkynes of the second material 32′).

While at least some of the resin layer 16 is capable of transmitting UV light (depending, in part, upon the thickness), it is to be understood that the resin layer 16 may also include an ultraviolet (UV) light blocking additive 30 (as shown in FIG. 1B and FIG. 1C) that is capable of reflecting and/or absorbing at least some UV light. Suitable examples of the UV light blocking material 30 for the resin layer 16 includes inorganic particles, such as carbon black, metal oxides (e.g., titanium dioxide, zinc oxide, zirconium dioxide, etc.), or combinations thereof. One specific example of a resin layer 16 having inorganic particles as the UV light blocking additive 30 is a titanium dioxide (TiO₂) doped acrylate resin. Other suitable examples of the UV light blocking additive 30 for the resin layer 16 include organic materials, such as triazole-based compounds, triazine-based compounds, dibenzoyl-based compounds, or combinations thereof. One specific example of a resin layer 16 having an organic material for the UV light blocking additive 30 is an avobenzone-doped acrylate resin.

In an example, the resin layer 16 includes from about 1 wt % to about 50 wt % of the UV light blocking additive 30, based on a total weight of the resin layer 16. In another example, the resin layer 16 includes from about 2 wt % to about 25 wt % of the UV light blocking additive 30, based on a total weight of the resin layer 16. In yet another example, the resin layer 16 includes from about 3 wt % to about 22.5 wt % of the UV light blocking additive 30, based on the total weight of the resin layer 16. In still another example, the resin layer 16 includes from about 15 wt % to about 20 wt % of the UV light blocking additive 30, based on the total weight of the resin layer 16.

The resin layer 16 may be any resin material with UV absorbance and/or transmittance that can be altered by adjusting its thickness and that can be fabricated to include the UV light blocking additive 30. As shown in FIG. 1B and FIG. 1C, the resin layer 16 may have a first (thinner) thickness T₁ at the depressions 18 and a second (thicker) thickness T₂ at the interstitial regions 20. Any of the previously listed resins may be used for the resin layer 16, with the understanding that the thicker portions, e.g., at T₂, of the resin layer 16 are fabricated to block UV light from reaching the interstitial regions 20 (when UV light is directed through the resin layer 16), while thinner portions e.g., T₁, of the resin layer 16 are fabricated to transmit sufficient UV light through the resin layer 16 to initiate desirable chemical reactions within the depressions 18.

In some examples, the resin layer 16 has thicker portions T₂ (underlying the interstitial regions 20) ranging from about 300 nm to about 600 nm and thinner portions T₁ (underlying the depressions 18) ranging from about 20 nm to about 200 nm. In these examples, the resin layer 16 will block UV light from transmitting through to the interstitial regions 20, and thus prevent the initiation of a UV light triggered reaction at the interstitial regions 20. In contrast, the resin layer 16 will transmit sufficient UV light through to the depressions 18, which will initiate a UV light triggered reaction within the depressions 18. In one example, the thicknesses T₁, T₂ are 150 nm and 500 nm, respectively, and a predetermined UV light dosage ranging from about 30 mJ/cm² to about 60 mJ/cm² may be used to achieve the selective UV light triggered reaction within the depression 18.

While some example ranges have been given for the thicknesses T₁, T₂ of the resin layer, it is to be understood that the material of the resin layer 16, the thicknesses T₁, T₂ of the resin layer 16, the predetermined UV light dosage, and the amount/type of UV light blocking additive 30 in the resin layer 16 may each be independently adjusted to achieve the desired UV-blockage at thicker portions T₂ of the resin layer 16 (e.g., portions underlying the interstitial regions 20) and to achieve the desired UV-transmittance at thinner portions T₁ of the resin layer 16 (e.g., portions underlying the depressions 18).

The correlation between predetermined UV light dosage, UV absorption constant, and resin layer 16 thickness can be expressed as:

$${D}_{0} = D \times exp ( - kd )$$

where D₀ is the predetermined UV dosage that is required to initiate a chemical reaction between UV reactive groups of the resin layer 16 and the functional material 22 within the depression 18, D is the actual UV dosage that is applied to the patterned substrate, k is the absorption constant of the resin, and d is the thickness T₁ of the resin layer 16 (e.g., at the thinner portion(s)). Thus, the actual UV dose (D) can be expressed as:

$$D = {D}_{0} / exp ( - kd )$$

It is to be understood that each of D, D₀, and k may depend, in part, upon the amount and the type of the UV light blocking additive 30 that is included in the resin layer 16. As described, during the fabrication of the patterned substrate, the resin layer 16 is deposited on the base support 14.

Suitable deposition techniques for the layer 16 include dip coating, dunk coating, spin coating, spray coating, puddle dispensing, ultrasonic spray coating, doctor blade coating, aerosol printing, screen printing, microcontact printing, etc. As described, the resin layer 16 is patterned to include depressions 18 separated by interstitial regions 20. Suitable patterning techniques for the layer 16 include photolithography, nanoimprint lithography (NIL), stamping techniques, embossing techniques, molding techniques, microetching techniques, etc. The deposition and patterning techniques that are used may depend, in part, upon the material used for the base support 14 and the material used for the resin layer 16.

Many different layouts of the depressions 18 may be envisaged, including regular, repeating, and non-regular patterns. In an example, the depressions 18 are disposed in a hexagonal grid for close packing and improved density. Other layouts may include, for example, rectilinear (rectangular) layouts, triangular layouts, and so forth. In some examples, the layout or pattern can be an x-y format in rows and columns. In some other examples, the layout or pattern can be a repeating arrangement of the depressions 18 and the interstitial regions 20. In still other examples, the layout or pattern can be a random arrangement of the depressions 18 and the interstitial regions 20.

The layout or pattern may be characterized with respect to the density (number) of the depressions 18 in a defined area. For example, the depressions 18 may be present at a density of approximately 2 million per mm². The density may be tuned to different densities including, for example, a density of about 100 per mm², about 1,000 per mm², about 0.1 million per mm², about 1 million per mm², about 2 million per mm², about 5 million per mm², about 10 million per mm², about 50 million per mm², or more, or less. It is to be further understood that the density can be between one of the lower values and one of the upper values selected from the ranges above, or that other densities (outside of the given ranges) may be used. As examples, a high density array may be characterized as having the depressions 18 separated by less than about 100 nm, a medium density array may be characterized as having the depressions 18 separated by about 400 nm to about 1 μm, and a low density array may be characterized as having the depressions 18 separated by greater than about 1 μm.

The layout or pattern of the depressions 18 may also or alternatively be characterized in terms of the average pitch, or the spacing from the center of one depression 18 to the center of an adjacent depression 18, or from the right edge of one depression 18 to the left edge of an adjacent depression 18 (edge-to-edge spacing). The pattern can be regular, such that the coefficient of variation around the average pitch is small, or the pattern can be non-regular in which case the coefficient of variation can be relatively large. In either case, the average pitch can be, for example, about 50 nm, about 0.1 μm, about 0.5 μm, about 1 μm, about 5 μm, about 10 μm, about 100 μm, or more or less. The average pitch for a particular pattern of depressions 18 can be between one of the lower values and one of the upper values selected from the ranges above. In an example, the depressions 18 have a pitch (center-to-center spacing) of about 1.5 μm. While example average pitch values have been provided, it is to be understood that other average pitch values may be used.

The size of each depression 18 may be characterized by its volume, opening area, depth, and/or diameter or length and width. For example, the volume can range from about 1×10−3 μm³ to about 100 μm³, e.g., about 1×10⁻² μm³, about 0.1 μm³, about 1 μm³, about 10 μm³, or more, or less. For another example, the opening area can range from about 1×10⁻³ μm² to about 100 μm², e.g., about 1×10⁻² μm², about 0.1 μm², about 1 μm², at least about 10 μm², or more, or less. For still another example, the depth can range from about 0.1 μm to about 100 μm, e.g., about 0.5 μm, about 1 μm, about 10 μm, or more, or less. For another example, the depth can range from about 0.1 μm to about 100 μm, e.g., about 0.5 μm, about 1 μm, about 10 μm, or more, or less. For yet another example, the diameter or each of the length and the width can range from about 0.1 μm to about 100 μm, e.g., about 0.5 μm, about 1 μm, about 10 μm, or more, or less.

It is to be understood that in the final flow cell 10, the depressions 18 are in fluid communication with the flow channel 11.

As shown in FIGS. 1B and 1n FIG. 1C, the depressions 18 include an attached functional material 22′ therein. The attached functional material 22′ is formed from a functional material 22 (see, e.g., FIG. 2B) that is susceptible to interaction (e.g., covalent attachment) with the resin layer 16 (e.g., that forms a bottom and sidewalls of the depressions 18) upon exposure to the predetermined UV light dosage.

In some examples, the functional material 22 may be a polymeric hydrogel. The polymeric hydrogel that is used as the functional material 22 is susceptible to interaction with the resin layer 16 when the polymeric hydrogel is in direct contact with the resin layer 16 and the interface of the materials is exposed to the predetermined UV light dosage. The UV light exposure initiates a chemical reaction that attaches the polymeric hydrogel to the resin layer 16 within the depressions. As such, the polymeric hydrogel and the resin layer 16 have respective functional groups that react with each other upon exposure to the predetermined light exposure.

In addition to including the UV responsive functional groups, the polymeric hydrogel can also swell when liquid is taken up and can contract when liquid is removed, e.g., by drying. In one specific example, the polymeric hydrogel includes an acrylamide copolymer, such as poly(N-(5-azidoacetamidylpentyl) acrylamide-co-acrylamide, PAZAM. PAZAM and some other forms of the acrylamide copolymer are represented by the following structure (I):

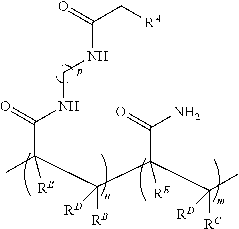

wherein:
R^{A} is selected from the group consisting of azido, optionally substituted amino (e.g., an aminooxy group), optionally substituted alkenyl, optionally substituted alkyne, halogen, optionally substituted hydrazone, optionally substituted hydrazine, carboxyl, hydroxy, optionally substituted tetrazole, optionally substituted tetrazine, nitrile oxide, nitrone, sulfate, and thiol;
R^{B} is H or optionally substituted alkyl;
R^{C}, R^{D}, and R^{E} are each independently selected from the group consisting of H and optionally substituted alkyl;
each of the —(CH₂)ₚ— can be optionally substituted;
p is an integer in the range of 1 to 50;
n is an integer in the range of 1 to 50,000; and
m is an integer in the range of 1 to 100,000.

One of ordinary skill in the art will recognize that the arrangement of the recurring “n” and “m” features in structure (I) are representative, and the monomeric subunits may be present in any order in the polymer structure (e.g., random, block, patterned, or a combination thereof).

The molecular weight of PAZAM and other forms of the acrylamide copolymer may range from about 5 kDa to about 1500 kDa or from about 10 kDa to about 1000 kDa, or may be, in a specific example, about 312 kDa.

In some examples, PAZAM and other forms of the acrylamide copolymer are linear polymers. In some other examples, PAZAM and other forms of the acrylamide copolymer are lightly cross-linked polymers.

In other examples, the polymeric hydrogel may be a variation of the structure (I). In one example, the acrylamide unit may be replaced with N,N-dimethylacrylamide

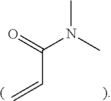

In this example, the acrylamide unit in structure (I) may be replaced with

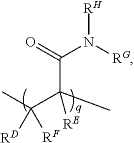

where R^{D}, R^{E}, and R^{F} are each H or a C1-C6 alkyl, and R^{G} and RH are each a C1-C6 alkyl (instead of H as is the case with the acrylamide). In this example, q may be an integer in the range of 1 to 100,000. In another example, the N,N-dimethylacrylamide may be used in addition to the acrylamide unit. In this example, structure (I) may include

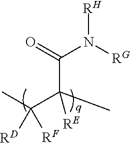

in addition to the recurring “n” and “m” features, where R^{D}, R^{E}, and R^{F} are each H or a C1-C6 alkyl, and R^{G} and RH are each a C1-C6 alkyl. In this example, q may be an integer in the range of 1 to 100,000.

As another example of the polymeric hydrogel, the recurring “n” feature in structure (I) may be replaced with a monomer including a heterocyclic azido group having structure (II):

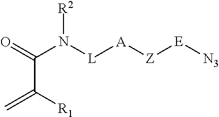

wherein R¹ is H or a C1-C6 alkyl; R₂ is H or a C1-C6 alkyl; L is a linker including a linear chain with 2 to 20 atoms selected from the group consisting of carbon, oxygen, and nitrogen and 10 optional substituents on the carbon and any nitrogen atoms in the chain; E is a linear chain including 1 to 4 atoms selected from the group consisting of carbon, oxygen and nitrogen, and optional substituents on the carbon and any nitrogen atoms in the chain; A is an N substituted amide with an H or a C1-C4 alkyl attached to the N; and Z is a nitrogen containing heterocycle.

Examples of Z include 5 to 10 carbon-containing ring members present as a single cyclic structure or a fused structure. Some specific examples of Z include pyrrolidinyl, pyridinyl, or pyrimidinyl.

As still another example, the polymeric hydrogel may include a recurring unit of each of structure (III) and (IV):

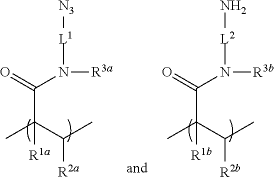

wherein each of R^{1a}, R^{2a}, R^{1b} and R^{2b} is independently selected from hydrogen, an optionally substituted alkyl or optionally substituted phenyl; each of R^{3a} and R^{3b} is independently selected from hydrogen, an optionally substituted alkyl, an optionally substituted phenyl, or an optionally substituted C7-C14 aralkyl; and each L¹ and L² is independently selected from an optionally substituted alkylene linker or an optionally substituted heteroalkylene linker.

The polymeric hydrogel may be prepared by polymerizing the monomer(s) that are to form the hydrogel. The polymerization process and process conditions will depend upon the monomer(s). In an example, the hydrogel may be synthesized using reversible addition-fragmentation chain transfer (RAFT) polymerization. While RAFT polymerization may be used, it is to be understood that other polymerization processes may also be used. Other suitable polymerization processes include atom transfer radical polymerization (ATRP), nitroxide mediated radical (NMP) polymerization in combination with RAFT or ATRP, NMP with an additional cross-linking step, cobalt-mediated polymerization, group transfer polymerization (GTP), ring opening polymerization (ROP), ionic polymerization, or any other polymerization process that either directly or indirectly yields the desired linear or branched architecture. In some instances, the polymerization of the polymeric hydrogel may be triggered by exposing the polymeric hydrogel to the predetermined UV light dosage (e.g., after the monomeric components of the polymeric hydrogel have been deposited within the depressions 18).

Methods for applying and selectively attaching the polymeric hydrogel in the depressions 18, and thus forming one example of the attached functional material 22′, are described below in reference to the FIGS. 2, 3, and 4 series. This example of the attached functional material 22′ is capable of grafting a primer set 24 (including primers 26, 28) thereto. As will be described in more detail in the description of the methods, the primers 26, 28 may be pre-grafted to the polymeric hydrogel, or may be grafted after the polymeric hydrogel is attached to the depressions 18 and after unattached polymeric hydrogel is removed from the interstitial regions 20.

While not shown in FIG. 1B or FIG. 1C, in other examples, the functional material 22 may be a functionalized particle. The functionalized particle includes any of the previously listed polymeric hydrogels coated on a core particle or may include the polymeric hydrogel as the particle itself (i.e., without a different core material). The surface of either example of the functionalized particle is the polymeric hydrogel, which is susceptible to interaction with the resin layer 16 when in direct contact therewith and when exposed to the predetermined UV light dosage.

The core particle may be inert to the various chemistries used throughout sequencing workflows. For example, the core particle can be inert to chemistry used to attach the primer(s) 26, 28 (e.g., of the primer set 24) to the polymeric hydrogel coating, or inert to the predetermined UV light dosage used to attach the polymeric hydrogel coating to the resin layer 16 within the depressions 18, etc.

Examples of suitable materials for the core particle include inert and/or magnetic particles (e.g., magnetic FeOₓ, silica coated FeOₓ), polymers (e.g., polytetrafluoroethylene (PTFE), some polyacrylics, polypropylene, polyethylene, polybutylene, polyurethanes, polystyrene and other styrene copolymers, nylon (i.e., polyamide), and polycaprolactone (PCL)), nitrocellulose, silica (SiO₂), silica-based materials (e.g., functionalized SiO₂), carbon, or metals.

To form the functionalized particle, the polymeric hydrogel may be formed and then coated on the core particle. The polymeric hydrogel may be prepared using any of the polymerization processes disclosed herein. The polymeric hydrogel may then be coated on the core using any suitable deposition techniques. Examples of suitable deposition techniques include dip coating, dunk coating, spin coating, spray coating, puddle dispensing, ultrasonic spray coating, etc. In an example, the core may be suspended in the polymeric hydrogel and exposed to conditions (e.g., heat) that will initiate the attachment of the polymeric hydrogel to the core. The type of attachment that is formed will depend upon the chemistry of the hydrogel and the core. It is to be understood that at least some of the functional groups of the polymeric hydrogel coating will be available for primer grafting and for UV initiated attachment to the resin layer 16.

In other examples, the polymeric hydrogel may be formed into particles.

When the polymeric hydrogel is used as a coating on the core particle, the thickness of the polymeric hydrogel coating on the core particle ranges from about 10 nm to about 200 nm. The hydrogel can be in a dry state or can be in a swollen state, where it uptakes liquid. The 10 nm thickness represents the hydrogel in the fully dry state, and the 200 nm thickness represents the hydrogel in the fully swollen state.

The particle size of the functionalized particle (including the thickness of the polymeric hydrogel when it is used as the coating) may be selected so that a single particle can be attached within each depression 18 defined in the resin layer 16. As such, the functionalized particle may be slightly smaller than the dimensions of the depression 18.

Methods for applying and selectively attaching the functionalized particles in the depressions 18, and thus forming another example of the attached functional material 22′, are described below in reference to the FIGS. 2, 3, and 4 series. This example of the attached functional material 22′ (i.e., the functionalized particle) is capable of grafting a primer set 24 (including primers 26, 28) to the polymeric hydrogel particle or the polymeric hydrogel coating. The primers 26, 28 may be pre-grafted to the polymeric hydrogel particle or the polymeric hydrogel coating of the functionalized particles, or may be grafted after the functionalized particles are attached in the depressions 18 and unattached functionalized particles are removed from the interstitial regions 20.

In examples in which the functional material 22 (used to form attached functional material 22′) is the functionalized particle that has primers 26, 28 pre-grafted thereto, the functionalized particle may be a “pre-clustered” functionalized particle. A “pre-clustered” functionalized particle includes the polymeric hydrogel particle or a core particle and the hydrogel coating thereon, and further includes primers 26, 28 attached to side chains or arms of the hydrogel, a plurality of amplicons attached to at least some of the primers 26, 28, and a surface attachment mechanism to attach to a UV reactive functional group of the resin layer 16 (within the depressions 18) upon exposure to the predetermined dosage of UV light. The surface attachment mechanism may be any of the UV reactive functional groups disclosed herein, and may be part of the polymeric hydrogel. The pre-clustered functionalized particle may be used for the generation of template nucleic acid strands (i.e., amplicons) that are to be sequenced. One example method of forming the pre-clustered functionalized particle will now be described.

At the outset of template strand formation, library templates may be prepared from any nucleic acid sample (e.g., a DNA sample or an RNA sample). The DNA nucleic acid sample may be fragmented into single-stranded, similarly sized (e.g., <1000 bp) DNA fragments. The RNA nucleic acid sample may be used to synthesize complementary DNA (cDNA), and the cDNA may be fragmented into single-stranded, similarly sized (e.g., <1000 bp) cDNA fragments. During preparation, adapters may be added to the ends of any of the fragments. Through reduced cycle amplification, different motifs may be introduced in the adapters, such as sequencing primer binding sites, indices, and regions that are complementary to the primers 26, 28 on the functionalized particles. In some examples, the fragments from a single nucleic acid sample have the same adapters added thereto. The final library templates include the DNA or cDNA fragment and adapters at both ends. The DNA or cDNA fragment represents the portion of the final library template that is to be sequenced.

A plurality of library templates may be introduced to a suspension which includes a liquid carrier and the functionalized particles described herein. Multiple library templates are hybridized, for example, to one of two types of primers 26, 28 that are immobilized to the polymeric hydrogel particle or the polymeric hydrogel coating on the core particle.

Amplification of the template nucleic acid strand(s) on the functionalized particles may be initiated to form functionalized particles with a cluster of the template stands. In one example, amplification involves cluster generation. In one example of cluster generation, the library templates are copied from the hybridized primers 26, 28 by 3′ extension using a high-fidelity DNA polymerase. The original library templates are denatured, leaving the copies immobilized all around the functionalized particles. Isothermal bridge amplification or some other form of amplification (e.g., exclusion amplification) may be used to amplify the immobilized copies. For example, the copied templates loop over to hybridize to an adjacent, complementary primer, and a polymerase copies the copied templates to form double stranded bridges, which are denatured to form two single stranded strands. These two strands loop over and hybridize to adjacent, complementary primers and are extended again to form two new double stranded loops. The process is repeated on each template copy by cycles of isothermal denaturation and amplification to create dense clonal clusters on the functionalized particles. Each cluster of double stranded bridges is denatured. In an example, the reverse strand is removed by specific base cleavage, leaving forward template strands. Clustering results in the formation of several template strands immobilized on the functionalized particles. This example of clustering is referred to as bridge amplification, and is one example of the amplification that may be performed. It is to be understood that other amplification techniques may be used.

The functionalized particles (whether pre-clustered or not), when used to form the attached functional material 22′, are capable of anchoring to the resin layer 16 that forms a bottom of the depression 18. Anchoring is possible via the surface attachment mechanism of the functionalized particle. The surface attachment mechanism may be any UV reactive functional group that is part of the polymeric hydrogel particle or the polymeric hydrogel coating of the functionalized particle. The UV reactive functional groups of the (pre-clustered) functionalized particles react with the UV reactive functional groups of the resin layer 16 within the depression 18 upon exposure to the predetermined UV light dosage.

As mentioned, each of the examples of the attached functional material 22′ described thus far includes a primer set 24 attached thereto. In the examples shown in FIG. 1B and FIG. 1C, the primer set 24 is attached to the polymeric hydrogel, which is one example of the attached functional material 22′. Alternatively, while not shown in FIG. 1B or FIG. 1C, the primer set 24 may be attached to the polymeric hydrogel particle or the polymeric hydrogel coating of the functionalized particle, which is another example of the attached functional material 22′.

In either example, the primer set 24 is attached to a polymeric hydrogel (e.g., coated on a core particle, the particle itself, or applied within the depression 18). The primer set 24 includes two different primers 26, 28 that may be used in sequential paired end sequencing. As examples, the primer set 24 may include P5 and P7 primers, P15 and P7 primers, or any combination of the PA primers, the PB primers, the PC primers, and the PD primers set forth herein. As further examples, the primer set 24 may include any two PA, PB, PC, and PD primers, or any combination of one PA primer and one PB, PC, or PD primer, or any combination of one PB primer and one PC or PD primer, or any combination of one PC primer and one PD primer. Examples of P5 and P7 primers are used on the surface of commercial flow cells sold by Illumina Inc. for sequencing, for example, on HISEQ™, HISEQX™, MISEQ™, MISEQDX™, MINISEQ™, NEXTSEQ™, NEXTSEQDX™, NOVASEQ™, ISEQ™, GENOME ANALYER™, and other instrument platforms. The P5 and P7 primers have a universal sequence for seeding and/or amplification purposes.

The P5 primer (which may be a cleavable primer due to the cleavable nucleobase uracil or “n”) is:

P5 #1: 5′ → 3′
(SEQ. ID. NO. 1)
AATGATACGGCGACCACCGAGAUCTACAC
P5 #2: 5′ → 3′
(SEQ. ID. NO. 2)
AATGATACGGCGACCACCGAGAnCTACAC

where “n” is inosine in SEQ. ID. NO. 2; or

P5 #3: 5′ → 3′
(SEQ. ID. NO. 3)
AATGATACGGCGACCACCGAGAnCTACAC

where “n” is alkene-thymidine (i.e., alkene-dT) in SEQ. ID. NO. 3.

The P7 primer (which may be a cleavable primer) may be any of the following:

P7 #1: 5′ → 3′
(SEQ. ID. NO. 4)
CAAGCAGAAGACGGCATACGAnAT
P7 #2: 5′ → 3′
(SEQ. ID. NO. 5)
CAAGCAGAAGACGGCATACnAGAT
P7 #3: 5′ → 3′
(SEQ. ID. NO. 6)
CAAGCAGAAGACGGCATACnAnAT

where “n” is 8-oxoguanine in each of the sequences.

Other examples of the P7 primer (which may be a cleavable primer) may be any of the following:

P7 #4: 5′ → 3′
(SEQ. ID. NO. 7)
CAAGCAGAAGACGGCATACGAUAT;
or
P7 #5: 5′ → 3′
(SEQ. ID. NO. 8)
CAAGCAGAAGACGGCATACUAGAT.

The P15 primer is:

P15: 5′ → 3′
(SEQ. ID. NO. 9)
AATGATACGGCGACCACCGAGAnCTACAC

where “n” is allyl-T (i.e., a thymine nucleotide analog having an allyl functionality).

The other primers (PA-PD) mentioned above include:

PA 5′ → 3′
(SEQ. ID. NO. 10)
GCTGGCACGTCCGAACGCTTCGTTAATCCGTTGAG
PB 5′ → 3′
(SEQ. ID. NO. 11)
CGTCGTCTGCCATGGCGCTTCGGTGGATATGAACT
PC 5′ → 3′
(SEQ. ID. NO. 12)
ACGGCCGCTAATATCAACGCGTCGAATCCGCAACT
PD 5′ → 3′
(SEQ. ID. NO. 13)
GCCGCGTTACGTTAGCCGGACTATTCGATGCAGC

While not shown in the example sequences for PA-PD, it is to be understood that any of these primers may include a cleavage site, such as uracil, 8-oxoguanine, allyl-T, etc. at any point in the strand.

It is to be understood that the cleavage sites of the primers 26, 28 in the primer set 24 are orthogonal to each other (i.e., one cleavage site is not susceptible to the cleaving agent used for the other cleavage site), so that after amplification, forward or reverse strands can be cleaved, leaving the other of the reverse or forward strands for sequencing.

In these examples, the 5′ terminal end of each primer 26, 28 includes a functional group that can attach to the surface groups of the polymeric hydrogel. The functional group at the 5′ terminal end of the primers 26, 28 enables the immobilization of the primers 26, 28 by single point covalent attachment. The attachment will depend, in part, on the functional groups of the polymeric hydrogel of the attached functional material 22′. Examples of terminated primers that may be used include a succinimidyl (NHS) ester terminated primer, an alkyne terminated primer (e.g., including a 5′ hexynyl group), a tetrazine terminated primer, an azido terminated primer, an amino terminated primer, an epoxy or glycidyl terminated primer, a thiophosphate terminated primer, a thiol terminated primer, an aldehyde terminated primer, a hydrazine terminated primer, a phosphoramidite terminated primer, and a triazolinedione terminated primer. In some specific examples, a succinimidyl (NHS) ester terminated primer may be reacted with an amine of the hydrogel, an aldehyde terminated primer may be reacted with a hydrazine of the hydrogel, an alkyne terminated primer may be reacted with an azide of the hydrogel, an azide terminated primer may be reacted with an alkyne or DBCO (dibenzocyclooctyne) of the hydrogel, an amino terminated primer may be reacted with an activated carboxylate group or NHS ester of the hydrogel, a thiol terminated primer may be reacted with an alkylating reactant (e.g., iodoacetamine or maleimide) of the hydrogel or a tetrazole of the hydrogel, or a phosphoramidite terminated primer may be reacted with a thioether of the hydrogel.

While several examples have been provided, it is to be understood that any functional group that can be attached to the 5′ end of the primers 26, 28 and that can attach to a functional group of the hydrogel may be used.

The primers 26, 28 may also include a linker between the primer sequence and the 5′ terminal end group. Example linkers include a polyT sequence. In some examples, the polyT region includes from 2 T bases to 20 T bases. As specific examples, the polyT region may include 3, 4, 5, 6, 7, or 10 T bases. Other suitable linkers are non-nucleic acid linkers, such as a polyethylene glycol chain, an alkyl group or a carbon chain, an aliphatic linker with vicinal diols, a peptide linker, etc. The following are some examples of nucleotides including non-nucleic acid linkers with terminal alkyne groups (where B is the nucleobase and “oligo” is the primer sequence):

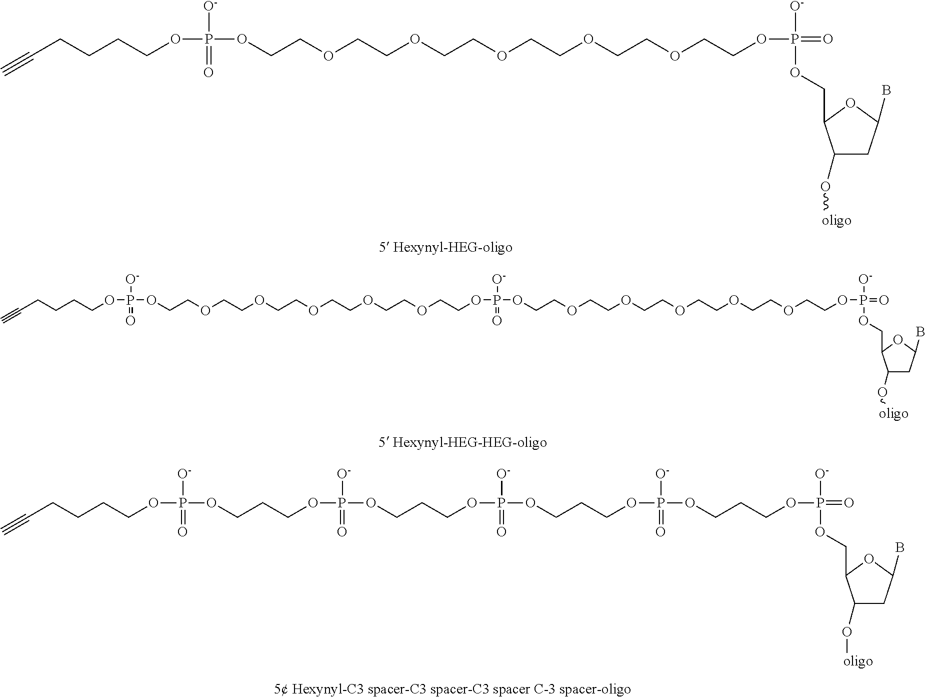

While the primer set 24 is shown as being attached to the polymeric hydrogel (attached functional material 22′) in FIG. 1B and FIG. 1C, it is to be understood that, in other examples, the primer set 24 itself acts as the attached functional material 22′. In these examples, the 5′ end of each primer 26, 28 of the primer set 24 is susceptible to interaction with the resin layer 16 (e.g., within the depressions 18) when placed in contact therewith and exposed to the predetermined UV light dosage. As such, in these examples, the 5′ terminal end functional group of each primer 26, 28 is capable of chemically reacting with surface functional groups of the resin layer 16 within the depressions 18 when exposed to UV light.

In some specific examples, a thiol terminated primer may be reacted with an alkene or alkyne of the resin layer 16 (via cycloaddition), an alkene or alkyne terminated primer may be reacted with a sydnone functional group of the resin layer 16 (via cycloaddition), or an alkene terminated primer may be reacted with an azirine functional group of the resin layer 16 (via cycloaddition). In another example, the terminated primer and the surface groups of the resin layer 16 are capable of undergoing a hetero-Diels-Alder reaction.

Referring now specifically to FIG. 1C, some examples of the flow cell architecture include a second material 32′ (e.g., that is formed from a second material 32) that is attached over the interstitial regions 20. The attached second material 32′ may be a passivating second material or a functionalizing second material.

When the attached second material 32′ is a passivating material, the second material 32′ may be a material that is capable of preventing the attachment of moieties (e.g., primers, labeled nucleotides introduced during sequencing, etc.) at the interstitial regions 20. The passivating attached second material 32′ may prevent a dye or a protein from attaching to the interstitial regions 20. Resins or polymeric hydrogels that include the UV reactive functional groups for attachment to the resin layer 16 but are not capable of attaching the primers 26, 28, labeled nucleotides introduced during sequencing, or other moieties that react within the depression 18 may be used as the passivating material.

When the attached second material 32′ is a functionalizing second material, in some examples, the attached second material 32′ may be any material that is capable of improving a signal-to-noise ratio (SNR) during sequencing operations to improve performance of the flow cell 10. As one of these examples, the functionalizing attached second material 32′ may be a dark quencher (e.g., carbon black) that reduces signals that may otherwise emit at the interstitial regions 20 (e.g., due to autofluorescence or non-specifically bound labeled nucleotides). As another of these examples, the attached functionalizing second material 32′ may be an anti-oxidant that reduces damage that may occur to DNA during sequencing, thus improving sequencing signals.

The dark quencher or anti-oxidant may be held to the interstitial regions 20 through a polymer layer, such as poly(N-isopropylacrylamide) (PNIPAAm). This type of polymer layer transitions between a hydrophilic state and a hydrophobic state, and thus can be controlled through its critical solution temperature. With this lower critical solution temperature (LCST) polymer, an increase in the temperature above the LOST collapses the co-polymer and suppresses the passivating moiety (i.e., the dark quencher or anti-oxidant). In contrast, a decrease in the temperature to below the LOST renders the co-polymer more hydrophilic, which expands the co-polymer causing it to expose the passivating moiety. The polymer layer is reversible between the two states, but the passivating moiety may be released during the expansion of the polymer layer, either in its initial expansion or after multiple cycles of expansion and contraction.

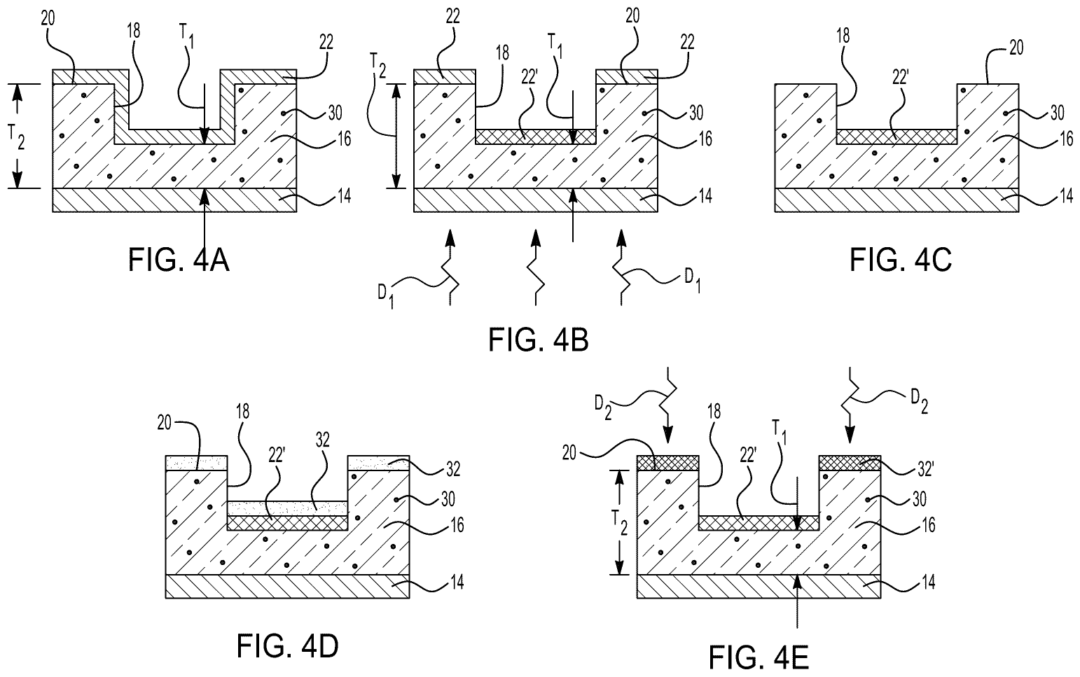

In some other examples in which the attached second material 32′ is the functionalizing second material, the second material 32 may be a material that is capable of grafting a primer set (e.g., a second primer set 24′) thereto and that is capable of attaching to the resin layer 16 at the interstitial regions 20 upon exposure to a predetermined UV light dosage. As an example, the attached second functional material 32′ may be a polymeric hydrogel. This is described further in reference to the example method(s) depicted in FIG. 4D and FIG. 4E. As will be further described, in these examples, two different primer sets 24A, 24B or 24A′, 24B′ may be used to facilitate simultaneous paired-end sequencing. One of the primer sets 24A or 24A′ may be attached to a polymeric hydrogel (e.g., attached functional material 22′) that is attached within the depressions 18 of the patterned substrate, and the other of the primer sets 24B or 24B′ may be attached to a polymeric hydrogel (e.g., attached second functionalizing material 32′) that is attached over the interstitial regions 20.

In some of the examples disclosed herein, the attached functional material 22′ and the attached second material 32′ are chemically the same, and some of the techniques disclosed herein may be used to immobilize the respective primer sets 24A, 24B or 24A′, 24B′ to the desired material 22′ or 32′. In other examples disclosed herein, the attached materials 22′ and 32′ are chemically different (e.g., include different functional groups for respective primer set, e.g., 24A or 24B, or 24A′ or 24B′ attachment), and some of the techniques disclosed herein may be used to immobilize the respective primer set, e.g., 24A or 24B, or 24A′ or 24B′ to the desired attached material 22′ or 32′. In other examples disclosed herein, the materials applied and exposed to UV light to form the attached materials 22′, 32′ may have the respective primer sets 24A or 24B, or 24A′ or 24B′ pre-grafted thereto, and thus the immobilization chemistries of the attached materials 22′, 32′ may be the same or different.

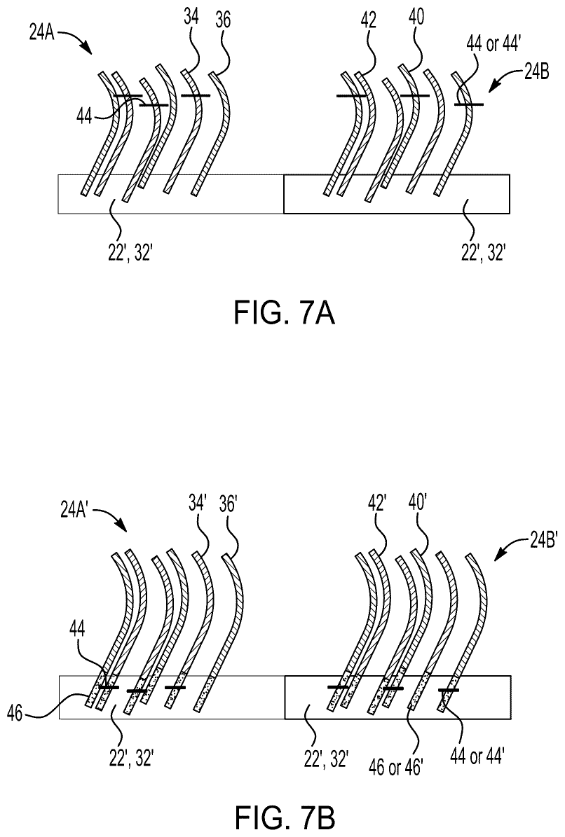

Specific examples of the primer sets are shown in FIG. 7A as 24A and 24B, and in FIG. 7B as 24A′ and 24B′.

The primer sets 24A, 24B and 24A′, 24B′ are related in that one set 24A, 24A′ includes a cleavable first primer 34, 34′ and an uncleavable second primer 36, 36′ and the other set 24B, 24B′ includes an uncleavable first primer 42, 42′ and a cleavable second primer 40, 40′. These primer sets 24A, 24B or 24A′, 24B′ allow a single template strand to be amplified and clustered across both primer sets 24A, 24B or 24A′, 24B′, and also enable the respective generation of forward and reverse strands on the attached material 22′ or 32′ due to the cleavage groups 44 and 44 or 44′ being present on the opposite primers of the sets 24A, 24B or 24A′, 24B′. It is to be understood that the prime (′) designations for the primers 34′, 36′, 40′, 42′ do not refer to complementary sequences to the primers 34, 36, 40, 42, but rather are additional examples of the type of primer.

Each of the first primer sets 24A, 24A′ includes a cleavable first primer 34 or 34′ and an uncleavable second primer 36 or 36′; and each of the second primer sets 24B, 24B′ includes an uncleavable first primer 42 or 42′ and a cleavable second primer 40 or 40′.

The uncleavable second primer 36 or 36′ and the cleavable first primer 34 or 34′ are oligonucleotide pairs, e.g., where the uncleavable second primer 36 or 36′ is a forward amplification primer and the cleavable first primer 34 or 34′ is a reverse amplification primer or where the uncleavable second primer 36 or 36′ is the reverse amplification primer and the cleavable first primer 34 or 34′ is the forward amplification primer. In each example of the primer set 24A, 24A′, the cleavable first primer 34 or 34′ includes a cleavage site 44, while the uncleavable second primer 36 or 36′ does not include a cleavage site 44.

The cleavable second primer 40 or 40′ and the uncleavable first primer 42 or 42′ are also oligonucleotide pairs, e.g., where the cleavable second primer 40 or 40′ is a forward amplification primer and the uncleavable first primer 42 or 42′ is a reverse amplification primer or where the uncleavable first primer 42 or 42′ is the forward amplification primer and the cleavable second primer 40 or 40′ is the reverse amplification primer. In each example of the second primer set 24B, 24B′, the cleavable second primer 40 or 40′ includes a cleavage site 44 or 44′, while the uncleavable first primer 42 or 42′ does not include a cleavage site 44 or 44′.

It is to be understood that the uncleavable second primer 36 or 36′ of the first primer set 24A, 24A′ and the cleavable second primer 40 or 40′ of the second primer set 24B, 24B′, have the same nucleotide sequence (e.g., both are forward amplification primers), except that the cleavable second primer 40 or 40′ includes the cleavage site 44 or 44′ integrated into the nucleotide sequence or into a linker 46 or 46′ attached to the nucleotide sequence. Similarly, the cleavable first primer 34 or 34′ of the first primer set 24A, 24A′ and the uncleavable first primer 42 or 42′ of the second primer set 24B, 24B′ have the same nucleotide sequence (e.g., both are reverse amplification primers), except that the cleavable first primer 34 or 34′ includes the cleavage site 44 integrated into the nucleotide sequence or into a linker 46 attached to the nucleotide sequence.

The uncleavable primers 36, 42 or 36′, 42′ may be any primers with a universal sequence for capture and/or amplification purposes, such as any of the P5 and P7 primers described herein in reference to FIG. 2A through FIG. 2D, or any combination of the P5, P7, P15, PA, PB, PC, and PD primers (e.g., P15 and P7, PA and PB or PA and PD, etc.).

These uncleavable primers 36, 42 or 36′, 42′ are “uncleavable” because they do not include a cleavage site 44, 44′. As such, the P5 sequence would not include the uracil, inosine, or alkene-thymidine and the P7 sequences would not include the 8-oxoguanine or uracil. It is to be understood that any suitable universal sequence can be used as the uncleavable primers 36, 42 or 36′, 42′.

Examples of cleavable primers 34, 40 or 34′, 40′ include the P5 and P7 primers or other universal sequence primers (e.g., the P15, PA, PB, PC, PD primers) with the respective cleavage sites 44, 44′, incorporated into the respective nucleic acid sequences (FIG. 7A), or into the linker 46, 46′ (FIG. 7B) that attaches the cleavable primers 34, 40 or 34′, 40′ to the attached material 22′ or 32′. Examples of suitable cleavage sites 44, 44′ include enzymatically cleavable nucleobases or chemically cleavable nucleobases, modified nucleobases, or other cleavable molecules (e.g., between nucleobases). Some specific examples of the cleavage sites 44, 44′ include uracil, 8-oxoguanine, or allyl-T (a thymine nucleotide analog having an allyl functionality). The cleavage sites 44, 44′ may be incorporated at any point in the strand or in the linker 46, 46′.

In any of the examples disclosed herein, the primer set 24A, 24B, 24A′, or 24B′ may also include a PX primer for capturing a library template seeding molecule. The density of the PX motifs should be relatively low in order to minimize polyclonality on the flow cell surface. The PX capture primer may be:

PX 5′ → 3′
(SEQ. ID. NO. 14)
AGGAGGAGGAGGAGGAGGAGGAGG

In the example shown in FIG. 7A, the primers 34, 36 and 40, 42 of the primer sets 24A and 24B are directly attached to the attached material 22′, 32′, for example, without a linker 46, 46′. The attached material 22′ or 32′ has surface functional groups that can immobilize the terminal groups at the 5′ end of the respective primers 34, 36 and 40, 42.

Also, in the example shown in FIG. 7A, the cleavage site 44, 44′ of each of the cleavable primers 34, 40 is incorporated into the sequence of the primer 34, 40. It is to be understood that the same type of cleavage site 44 or different types of cleavage sites 44, 44′ may be used in the cleavable primers 34, 40 of the respective primer sets 24A, 24B. As an example, the cleavage sites 44 are uracil bases, and the cleavable primers 34, 40 are P5U (SEQ. ID. NO. 1) and P7U (SEQ. ID. NO. 7 or SEQ. ID. NO. 8), respectively. It is to be understood that any other cleavable nucleotide that can be incorporated by a polymerase may be used as the cleavage site 44. The uracil bases or other cleavage sites may also be incorporated into any of the PA, PB, PC, and PD primers to generate the cleavable primers 34, 40. In this example, the uncleavable primer 36 of the oligonucleotide pair 34, 36 may be P7 (any of the P7 sequences described herein without the cleavage site), and the uncleavable primer of the oligonucleotide pair 40, 42 may be P5 (any of the P5 sequences described herein without the cleavage site). Thus, in this example, the first primer set 24A includes P7, P5U and the second primer set 24B includes P5, P7U. The primer sets 24A, 24B have opposite linearization chemistries, which, after amplification, cluster generation, and linearization, allows forward template strands to be formed on the attached material 22′ or 32′, and reverse strands to be formed on the other attached material 32′ or 22′.

In the example shown in FIG. 7B, the primers 34′, 36′ and 40′, 42′ of the primer sets 24A′, 24B′ are attached to the respective attached material 22′ or 32′ through linkers 46 or 46, 46′. The attached material 22′ or 32′ has surface functional groups that can immobilize the terminal groups of the linkers 46 at the 5′ end of the primers 34′, 36′. The attached material 32′ or 22′ has surface functional groups that can immobilize the terminal groups of the linkers 46 or 46′ at the 5′ end of the primers 40′, 42′.

Examples of suitable linkers 46, 46′ may include nucleic acid linkers (e.g., 10 nucleotides or less) or non-nucleic acid linkers, such as a polyethylene glycol chain, an alkyl group or a carbon chain, an aliphatic linker with vicinal diols, a peptide linker, etc. Any of the linkers described herein may be used for the linkers 46, 46′.

In the example shown in FIG. 7B, the primers 34′, 42′ have the same sequence (e.g., P5 without the cleavage site) and the same linkers 46 or different linkers 46, 46′. The primer 42′ is uncleavable (i.e., no cleavage site), whereas the primer 34′ includes the cleavage site 44 incorporated into the linker 46 (as opposed to the primer sequence). Also in this example, the primers 36′, 40′ have the same sequence (e.g., P7 without the cleavage site) and the same linkers 46 or different linkers 46, 46′. The primer 36′ is uncleavable, and the primer 40′ includes the cleavage site 44 or 44′ incorporated into the linker 46 or 46′ (as opposed to the primer sequence). The same type of cleavage site 44 or different types of cleavage sites 44, 44′ may be used in the linkers 46 or 46, 46′ of the cleavable primers 34′, 40′. The primer sets 24A′, 24B′ have opposite linearization chemistries, which, after amplification, cluster generation, and linearization, allows forward template strands to be formed on one of the attached materials 22′ or 32′, and reverse strands to be formed on the other of the attached materials 32′ or 22′.

While the cleavage sites 44 or 44, 44′ are shown as part of the linkers 46 or 46, 46′ in FIG. 7B, it is to be understood that the cleavage sites 44 or 44, 44′ of the primers 34′, 40′ may be incorporated into the primer sequence rather than into the linkers 46 or 46, 46′.

In the examples shown in FIG. 7A and FIG. 7B, the attachment of the primers 34, 36 and 40, 42 or 34′, 36′ and 40′, 42′ to the attached functional material 22′ or the attached second material 32′ leaves a template-specific portion of the primers 34, 36 and 40, 42 or 34′, 36′ and 40′, 42′ free to anneal to its cognate template and the 3′ hydroxyl group free for primer extension.

Several methods of patterning flow cells that utilize the predetermined UV light dosage to trigger the chemical attachment of the functional material 22 (e.g., to the resin layer 16 within the depressions 18 of the flow cell 10) will now be described.

### Method of Forming a Flow Cell Including a Single Patterned Substrate

The method depicted in FIG. 2A through FIG. 2D generally includes depositing a functional material 22 over a resin layer 16 including depressions 18 separated by interstitial regions 20, wherein: the resin layer 16 includes an ultraviolet (UV) light blocking additive 30; the depressions 18 overlie a first portion of the resin layer 16 having a first thickness T₁, and the interstitial regions 20 overlie a second portion of the resin layer 16 having a second thickness T₂ that is greater than the first thickness T₁; and the functional material 22 is susceptible to interaction with the resin layer 16 when exposed to UV light; and directing, through the resin layer 16, a predetermined UV light dosage, whereby the functional material 22 within the depressions 18 is exposed to the predetermined UV light dosage and attaches to the resin layer 16 within the depressions 18, and the functional material 22 overlying the interstitial regions 20 is blocked from being exposed to the predetermined UV light dosage by the second resin portion.

It is to be understood that the examples of the method shown in FIG. 2A through FIG. 2D may be performed with the base support 14 (e.g., upon which the resin of the resin layer 16 may be applied and cured).

Any suitable resin material described herein may be used to form the resin layer 16 (e.g., a thiol-based resin, an acrylate resin, etc.), and any examples of the UV light blocking additives 30 are included in the resin material. Further, any suitable deposition technique disclosed herein may be used to deposit the resin (that forms the resin layer 16) on the base support 14. Still further, the base support 14 may be any base support 14 material described herein.

After the resin is applied to the base support 14, the resin may be soft baked to remove any excess solvent that is present in the resin. The soft bake may take place at a lower temperature than is used for curing the resin (e.g., ranging from about 50° C. to about 150° C.) and for a time ranging from greater than 0 seconds to about 3 minutes. In an example, the soft bake time ranges from about 30 seconds to about 2.5 minutes.

After the resin has been applied to the base support 14 and, in some instances, soft baked, the depression 18 and interstitial regions 20 are defined (forming the resin layer 16). While a single depression 18 is shown in the method depicted in FIG. 2A through FIG. 2D, it is to be understood that the flow cell 10 may include a plurality of depressions 18, where each individual depression 18 is separated from each other depression 18 by interstitial regions 20 (similar to that shown in FIG. 1B and FIG. 1C).

The depression 18 may be formed in the resin using any suitable technique described herein, such as nanoimprint lithography (NIL) or photolithography, etc. As one example of forming the depression 18, a working stamp 34 may be pressed into the resin while the resin is soft, which creates an imprint of the working stamp 34 in the resin. The resin may then be cured with the working stamp 34 in place. Curing may be accomplished by exposure to actinic radiation or heat. In an example, curing of the resin may be accomplished by exposing the applied resin to incident light at an energy dose ranging from about 0.5 J to about 20 J for 30 seconds or less. The incident light may be actinic radiation, such as ultraviolet (UV) radiation. In one example, the majority of the UV radiation emitted may have a wavelength of about 365 nm. The curing process may include a single UV exposure stage. The curing process forms the resin layer 16, which is patterned with the depression(s) 18 and interstitial regions 20.

In some instances, it may be desirable to perform a post-curing bake process. If performed, the post-curing bake may take place at a temperature ranging from about 150° C. to about 250° C. for a time ranging from about 1 minute to about 2 minutes.

After curing, and in some instances the post-curing bake, the working stamp 34 is released to reveal the resin layer 16. More specifically and as shown in FIG. 2A, the release of the working stamp 34 from the resin layer 16 exposes the depression 18 in the layer 16.

As further shown in FIG. 2A, the portion of the resin layer 16 underlying the depression 18 has the first thickness T₁, and portions of the resin layer 16 defines/underlies the interstitial regions 20 have the second thickness T₂ that is greater than the first thickness T₁. To create the patterned resin layer 16 with the desired thicknesses T₁, T₂ in the desired areas, the resin layer 16 is first deposited at a desired thickness that corresponds with the thickness T₂. Then, when the depression 18 is formed, the dimensions of the working stamp 34 are selected so that the depression 18 extends a desired depth into the total thickness (i.e., T₂) of the resin layer 16 and thus leaves the portion with the first thickness T₁ at the bottom of the depression 18.

With the depression 18 formed in the resin layer 16, this example method continues with the application of a functional material 22 over the resin layer 16 (e.g., over the depression(s) 18 and over the interstitial regions 20), as shown in FIG. 2B. As described, the functional material 22 includes a functional group that is susceptible to interaction with the resin layer 16 when applied thereto and upon exposure to the predetermined UV light dosage.

In the example shown in FIG. 2B, the functional material 22 is the polymeric hydrogel that attaches to the resin layer 16 within the depression 18 when exposed to the predetermined UV light dosage. The polymeric hydrogel may be any of the polymeric hydrogel materials disclosed herein, and may be deposited using any suitable deposition technique. In some instances, prior to being deposited in the depression 18, the polymeric hydrogel may first be diluted using water or another suitable solvent (e.g., up to 10% dilution). Examples of suitable solvents include dimethyl sulfoxide (DMSO), isopropyl alcohol (IPA), or a mixture of either of these solvent with water.

While the functional material 22 shown in FIG. 2B is depicted as a layer of the polymeric hydrogel, it is to be understood that any example of the functional material 22 set forth herein may be used instead of the polymeric hydrogel layer.

In one example, the functional material 22 is the functionalized particle (i.e., the polymeric hydrogel particle or the polymeric hydrogel that is coated on the core particle, either of which attaches to the resin layer 16 within the depressions 18 when exposed to the predetermined UV light dosage). The functionalized particle may be pre-clustered or non-pre-clustered. In this example, the polymeric hydrogel may be any of the polymeric hydrogel materials disclosed herein, and when included, the core particle may include any of the core particle materials disclosed herein. Further in this example, the functionalized particle (either pre-clustered or non-pre-clustered) may be suspended in a liquid carrier prior to its introduction into the flow cell 10.

In this example, the functionalized particles (pre-clustered or not) may be suspended in a liquid carrier. Any liquid carrier that does not solubilize the particle itself may be used. Examples of the liquid carrier include a buffer (e.g., a Tris-HCl buffer or 0.5× saline sodium citrate (SSC) buffer), acetic acid, acetone, acetonitrile, benzene, butanol, diethylene glycol, diethyl ether, dimethyl formamide, ethanol, glycerin, methane, pyridine, triethyl amine, etc. Surfactants/dispersants, such as sodium dodecyl sulfate (SDS), (CTAB) may also be included. This suspension may be introduced to the flow cell, and remain in the flow cell during UV exposure.

In another example, the functional material 22 includes the primer set 24 (which itself includes primers 26, 28) that attaches to the resin layer 16 within the depressions 18 when exposed to the predetermined UV light dosage. In this example, the flow cell 10 may be free of any polymeric hydrogel(s) and the primer set 24 may become directly attached to the resin layer 16 within the depressions 18 upon exposure to the predetermined UV light dosage. The primer set 24 (including primers 26, 28) may include any of the oligonucleotide primers disclosed herein, provided that the primers 26, 28 have orthogonal cleaving groups to separately generate forward and reverse strands. In some examples, the primer set 24 is suspended in a liquid carrier at a concentration ranging from 1 μM to 4 μM prior to its introduction into the flow cell 10.

As shown in FIG. 2C, following the application of the functional material 22, this example method continues by directing the predetermined UV light dosage through (a bottom) of the resin layer 16, which is represented by the arrows in FIG. 2C. During this process, the functional material 22 within the depression 18 is exposed to the predetermined UV light dosage, which initiates a chemical reaction (e.g., between the functional material 22 and the resin layer 16) and forms the attached functional material 22′ within the depression 18. This exposure may be facilitated by the (thinner) thickness T₁ of the portion of the resin layer 16 underlying the depression 18. At this thickness T₁, the resin layer 16 is capable of transmitting at least 25% of the predetermined UV light dosage through to the functional material 22 in the depression 18. It is to be understood that the amount of the UV light blocking additives 30 at the portion of the resin layer 16 having thickness T₁ is low enough that the additive 30 (in the portion) allows the transmission of sufficient UV light to initiate the desired UV-triggered reaction within the depression 18.

It is to be understood, however, that during this process, the functional material 22 over the interstitial regions 20 will not be exposed to sufficient UV light to trigger a chemical reaction at the interstitial regions 20. The portion of the resin layer 16 having thickness T₂ blocks 75% or more of UV light that is directed toward the resin layer 16, and thus the interface between the resin layer 16 and the functional material 22 over the interstitial regions 20 is not exposed to the predetermined UV light dosage. Moreover, the amount of the UV light blocking additive 30 at the portion of the resin layer 16 having thickness T₂ is high enough that the additive 30 does contribute to blocking the UV light. As such, the chemical reaction between the UV reactive groups (of components 22, 16) is not initiated and the functional material 22 will not attach to portion(s) of the resin layer 16 that form/underlie the interstitial regions 20.

When the functional material 22 is the polymeric hydrogel, exposure of the functional material 22 within the depression 18 to the predetermined UV light dosage triggers the chemical reaction between the respective UV reactive groups of the polymeric hydrogel and the resin layer 16. This reaction attaches the polymeric hydrogel to the resin layer 16, and forms one example of attached functional material 22′ at the bottom of the depression 18. In some instances, exposure to the predetermined UV light may also initiate polymerization of the polymeric hydrogel.

When the functional material 22 is the functionalized particle (e.g., pre-clustered or non-pre-clustered), exposure of the functional material 22 within the depression 18 to the predetermined UV light dosage triggers the chemical reaction between UV reactive groups of the resin layer 16 and i) the UV reactive groups of the polymeric hydrogel particle, or ii) the UV reactive groups of the polymeric hydrogel coating. This reaction attaches the polymeric hydrogel particle or the polymeric hydrogel coating to the resin layer 16, and forms another example of the attached functional material 22′ at the bottom of the depression 18. As mentioned above, the core (when included) of the functionalized particle may be inert, e.g., to the UV light and/or to light and/or reagents used in sequencing, and thus does not interfere with either the attachment of the functionalized particle to the depression 18 or downstream sequencing.

When the functional material 22 is the primer set 24 (including primers 26, 28), exposure of the functional material 22 to the predetermined UV light dosage triggers the chemical reaction between the respective UV reactive groups of the primers 26, 28 and the resin layer 16. This reaction attaches the primers 26, 28 to the resin layer 16 at the bottom of the depression 18.

It is to be understood that exposure of any example of the functional material 22 to the predetermined UV light dosage can initiate a variety of desirable UV light-triggered chemical reactions with the resin material 16 within the depression 18. As examples, exposure of the functional material 22 within the depression 18 to the predetermined UV light dosage can be used to initiate: a thiol-ene or thiol-yne cycloaddition reaction, a hetero-Diels-Alder reaction, a sydnone-alkene or alkyne cycloaddition reaction, an azirine-alkene cycloaddition reaction, oxime ligation, and others.

As shown in FIG. 2D, following the exposure of select portions of the functional material 22 to the predetermined UV light dosage and the formation of the attached functional material 22′ within the depression 18, the method continues with the removal of the (unattached) functional material 22 from the interstitial regions 20. Relatively simple removal techniques, such as sonication, washing, rinsing, wiping, etc., may be used because, in this example method, the functional material 22 does not attach (e.g., covalently) to the resin layer 16 at the interstitial regions 20. Thus, removal of the (unattached) functional material 22 from the interstitial regions 20 may be performed without polishing. The removal of the unattached functional material 22 exposes a surface of the resin layer 16 that forms the interstitial regions 20.

While not shown in FIG. 2A through FIG. 2D, in some examples of the method where the attached functional material 22′ is the polymeric hydrogel, the method may further include grafting the primer set 24 (including primers 26, 28) to the attached polymeric hydrogel (e.g., after the UV light exposure and removal of unattached functional material 22). In other examples, the functional material 22 is the polymeric hydrogel, and the polymeric hydrogel is pre-grafted with the primer set 24.

Further, while not shown in FIG. 2A through FIG. 2D, in some examples of the method where the attached functional material 22′ is the polymeric hydrogel that is coated on the core particle and that attaches to the resin layer 16 within the depression 18 when exposed to the predetermined UV light dosage (i.e., is the functionalized particle), the method may further include grafting the primer set 24 (including primers 26, 28) to the polymeric hydrogel that is coated on the core particle (e.g., after the UV light exposure and removal of unattached functional material 22). In other examples, the attached functional material 22′ is the polymeric hydrogel particle, and the method may further include grafting the primer set 24 (including primers 26, 28) to the polymeric hydrogel particle (e.g., after the UV light exposure and removal of unattached functional material 22). In still other examples, the functional material 22 is the functionalized particle, and the polymeric hydrogel coating is pre-grafted with the primer set 24. In some of these examples, in which the functional material 22 is the functionalized particle that is pre-grafted with the primer set 24, the functionalized particle may be pre-clustered, as described herein.

Whether the polymeric hydrogel is used alone or as the coating on the core particle, grafting of the primer set 24 to the polymeric hydrogel (of the functional material 22) may involve dunk coating, which involves immersing the patterned substrate (with the hydrogel attached in the depression 18) in a primer solution or mixture. The solution or mixture may include the primers 26, 28, water, a buffer, and a catalyst. Other grafting techniques may involve spray coating, puddle dispensing, or another suitable method that will attach the primer(s) 26, 28 to the hydrogel. With any of the grafting methods, the primers 26, 28 react with reactive groups of the polymeric hydrogel and form a chemical bond, thereby attaching the primers 26, 28 to the polymeric hydrogel.

The patterned structure that is formed using the method of FIG. 2A through FIG. 2D may be attached to a lid or another patterned structure to form the flow cell 10. Bonding may take place before or after primer grafting. When bonding is performed before primer grafting, it is to be understood that primer grafting may be performed using a flow through technique. When two patterned structures formed using the method of FIG. 2A through FIG. 2D are bonded together before primer grafting, the respective surfaces maybe grafted simultaneously using the flow through technique.

The patterned structure and the lid or the second patterned structure may be bonded using any suitable technique, such as laser bonding, diffusion bonding, anodic bonding, eutectic bonding, plasma activation bonding, glass frit bonding, or others methods known in the art.

### Method of Forming a Flow Cell Including Two Patterned Substrates

The method in FIG. 3A through FIG. 3C generally includes introducing a functional material 22 into a flow cell 10 including two patterned substrates, each of the patterned substrates including a resin layer 16 having depressions 18 separated by interstitial regions 20, wherein: the resin layers 16 include an ultraviolet (UV) light blocking additive 30; the depressions 18 of each of the two patterned substrates overlie a first portion of the resin layer 16 having a first thickness T₁ and the interstitial regions 20 of each of the two patterned substrates overlie a second portion of the resin layer 16 having a second thickness T₂ that is greater than the first thickness T₁; and the functional material 22 is susceptible to interaction with the resin layer 16 of each of the two patterned substrates when exposed to UV light; and simultaneously directing, through the resin layer 16 of each of the two patterned substrates, a predetermined UV light dosage, whereby some of the functional material 22 within the depressions 18 of a first of the two patterned substrates is exposed to the predetermined UV light dosage and attaches to the resin layer 16 within the depressions 18 of the first of the two patterned substrates, some other of the functional material 22 within the depressions 18 of a second of the two patterned substrates is exposed to the predetermined UV light dosage and attaches to the resin layer 16 within the depressions 18 of the second of the two patterned substrates, and the functional material 22 in contact with the interstitial regions 20 of each of the two patterned substrates is blocked from being exposed to the predetermined UV light dosage by the second resin portion. In some examples of the method, the unattached functional material 22 may then be removed.

As mentioned, the method shown in FIG. 3A through FIG. 3C involves a flow cell 10′ that includes two patterned structures. Prior to initiating the method, each of the patterned structures is formed and the two are bonded together at the bonding regions 38 to form the flow cell 10′. Each of the patterned structures includes the resin layer 16 patterned with the depressions 18.

As shown in FIG. 3A through FIG. 3C, the resin layer 16 may be applied directly over the base support 14. The resin included in the resin layer 16 of each of the first and the second of the two patterned substrates may be any of the resin materials disclosed herein and also includes the UV light blocking additive 30, and the base support 14 may be any of the base support 14 materials described herein. To generate the patterned structures, the resin may be applied, patterned, and cured using any suitable method described herein.

As shown in FIG. 3A, a plurality of depressions 18 is defined in the resin layer 16 of each of the first and the second of the two patterned substrates, each depression 18 being separated from each other depression 18 by interstitial regions 20. It is to be understood that the resin layer 16 of each of the first and the second of the two patterned substrates is first deposited at a desired thickness that corresponds with the thickness T₂. Then, when the depressions 18 are formed via nanoimprint lithography, the dimensions of the working stamp 34 are selected so that the depressions 18 extend a desired depth into the total thickness (i.e., T₂) of the resin and thus leave the portion with the first thickness T₁ at the bottom of each of the depressions 18.

In the example shown in FIG. 3A, the patterned structures are then bonded together to generate one example of the flow cell 10′. As depicted, the spacer layer 36 is applied to the bonding regions 38 of one or both of the patterned structures and then the patterned structures are placed into contact at the bonding regions 38. The spacer layer 36 is allowed to dry or is cured to create points of attachment. As illustrated, the flow channel 11 is created between the bonded patterned structures.

With the flow cell 10′ formed, this example method continues with the introduction of a functional material 22 into the flow cell 10′. The functional material 22 is applied such that it is in contact with the depressions 18 and the interstitial regions 20 of each of the first and the second of the two patterned substrates. As described herein, the functional material 22 is susceptible to interaction with (e.g., attachment to) the resin layer 16 of both of the patterned substrates upon exposure to the predetermined UV light dosage.

In the example shown in FIG. 3A through FIG. 3C, the functional material 22 is shown as a polymeric hydrogel that attaches to the resin layer 16 within the depressions 18 of each of the first and the second of the two patterned substrates when exposed to the predetermined UV light dosage. In this example, the polymeric hydrogel may be any of the polymeric hydrogel materials disclosed herein.

In another example, the functional material 22 may be the polymeric hydrogel particle or the polymeric hydrogel that is coated on the core particle (e.g., functionalized particle) and that attaches to the resin layer 16 within the depressions 18 of each of the first and the second of the two patterned substrates when exposed to the predetermined UV light dosage. In some examples, the functionalized particle may be pre-grafted with primers 26, 28 and may further be pre-clustered. The polymeric hydrogel particle or the polymeric hydrogel coating may be any of the polymeric hydrogel materials disclosed herein, and the core particle (when used) may be any of the core particle materials disclosed herein.

In still another example, the functional material 22 includes a primer set 24 (including primers 26, 28) that attaches directly to the resin layer 16 within the depressions 18 of each of the first and the second of the two patterned substrates when exposed to the predetermined UV light dosage. In this example, the flow cell 10′ may be free of any polymeric hydrogel(s), and the primer set 24 may become directly attached to the resin layer 16 (within the depressions 18) of each of the first and the second of the two patterned substrates upon exposure to the predetermined UV light dosage. The primer set 24 (including primers 26, 28) may include any of the oligonucleotide primers disclosed herein, provided that the primers 26, 28 have orthogonal cleaving groups to separately generate forward and reverse strands.

Regardless of the functional material 22 used, the functional material 22 may be incorporated into a liquid carrier (examples of which are described in reference to FIG. 2B) and introduced into the flow cell 10′ via the inlet. As depicted in FIG. 3A, enough of the liquid carrier is added to fill the flow channel 11 so that some of the functional material 22 can be in contact with the depressions 18 of each of the resin layers 16.

As shown in FIG. 3B, following the introduction of the functional material 22 to the flow cell 10′, this example method continues by directing a predetermined UV light dosage through both sides of the flow cell 10′ (e.g., through the resin layer 16 of each of the first and the second two patterned substrates). In this example, two different UV light sources may be used, which respectively direct the predetermined UV light dosage through the resin layer 16 toward the flow channel 11. The UV light is represented by the arrows in FIG. 3C.

During this process, the functional material 22 within the depressions 18 of each of the two patterned substrates is exposed to the respective predetermined UV light dosage directed thereto. This exposure may be facilitated by the thickness T₁ of the portion of each of the resin layers 16, which transmits the UV light and enables it to reach the functional material 22 in the depressions 18. More specifically, at this thickness T₁, each resin layer 16 is capable of transmitting at least 25% of the predetermined UV light dosage through to the functional material 22 in the depressions 18. This exposure initiates a chemical reaction (e.g., between the functional material 22 and the respective resin layer 16) and forms the attached functional material 22′ within the depressions 18. It is to be understood that the amount of the UV light blocking additive 30 at the portion of the resin layer 16 having thickness T₁ is low enough that the additive 30 does not interfere with the desired UV light transmission.

Also during this process, the functional material 22 in the flow channel 11 that is in contact with the interstitial regions 20 will not be exposed to sufficient UV light to trigger a chemical reaction at the interstitial regions 20. The portion of the resin layers 16 having thickness T₂ blocks 75% or more of UV light that is directed toward the respective resin layer 16, and thus the interface between the respective resin layers 16 and the functional material 22 in contact with the interstitial regions 20 is not exposed to the predetermined UV light dosage. Moreover, the amount of the UV light blocking additive 30 at the portion of the resin layers 16 having thickness T₂ is high enough that the additive 30 does contribute to blocking the UV light. As such, the chemical reaction between the UV reactive groups (of components 22, 16) is not initiated and the functional material 22 will not attach to portion(s) of the resin layers 16 that form the interstitial regions 20.

When the functional material 22 is the polymeric hydrogel, exposure of the functional material 22 within the depressions 18 to the predetermined UV light dosage triggers the chemical reaction between the respective UV reactive groups of the polymeric hydrogel and the resin layers 16. This reaction attaches the polymeric hydrogel to the resin layers 16, and forms one example of attached functional material 22′ within the depressions 18.

When the functional material 22 is the functionalized particle (pre-clustered or non-pre-clustered), exposure of the functional material 22 within the depressions 18 to the predetermined UV light dosage triggers the chemical reaction between the UV reactive groups of the resin layer 16 and i) UV reactive groups of the polymeric hydrogel coating or ii) UV reactive groups of the polymeric hydrogel particle. This reaction attaches the polymeric hydrogel particle or coating to the resin layer 16, and forms another example of the attached functional material 22′ within the depressions 18. In one example, a single functionalized particle may become attached within a single depression 18.

When the functional material 22 is the primer set 24 (including primers 26, 28), exposure of the functional material 22 to the predetermined UV light dosage triggers the chemical reaction between the respective UV reactive groups of the primers 26, 28 and the resin layers 16. This reaction attaches the primers 26, 28 to the resin layers 16 within the depressions 18.

It is to be understood that exposure of any example of the functional material 22 to the predetermined UV light dosages can initiate a variety of chemical reactions within the depressions 18 of each of the first and the second of the two patterned substrates, depending in part upon the material used for the functional material 22 and on a desired point of attachment for the functional material 22. As examples, exposure of the functional material 22 to the predetermined UV light dosage can be used to initiate: a thiol-ene or thiol-yne cycloaddition reaction, a hetero-Diels-Alder reaction, a sydnone-alkene or alkyne cycloaddition reaction, an azirine-alkene cycloaddition reaction, oxime ligation, and others.

As shown in FIG. 3C, following the exposure of the functional material 22 to the predetermined UV light dosage and the formation of attached functional material 22′ within the depressions 18 of each of the first and the second of the two patterned substrates, the method continues with the removal of the (unattached) functional material 22 from the interstitial regions 20 of each of the two patterned substrates. The unattached functional material 22 may be removed using any suitable method, such as a wash cycle, where a washing solution (e.g., buffer) is directed into, through, and then out of the flow channel 11 (that is defined between the two patterned substrates). The flow cell 10′ may be exposed to sonication while the washing solution is present in the flow channel 11 to speed up the removal of the unattached functional material 22.

While not shown in FIG. 3A through FIG. 3C, in examples of the method where the attached functional material 22′ is the polymeric hydrogel, the method may further include grafting the primer set 24 (including primers 26, 28) to the polymeric hydrogel (e.g., after the UV light exposure and removal of unattached functional material 22). In other examples, the functional material 22 is the polymeric hydrogel, and the polymeric hydrogel is pre-grafted with the primer set 24.

Further, while not shown in FIG. 3A through FIG. 3C, in some examples of the method where the functional material 22 is the polymeric hydrogel that is coated on a core particle and that attaches to the resin layer 16 within the depressions 18 of each of the first and the second of the two patterned substrates when exposed to the predetermined UV light dosage (i.e., is the functionalized particle), the method may further include grafting the primer set 24 (including primers 26, 28) to the polymeric hydrogel that is coated on the core particle (e.g., after the UV light exposure and removal of unattached functional material 22). In other examples, the attached functional material 22′ is the polymeric hydrogel particle, and the method may further include grafting the primer set 24 (including primers 26, 28) to the polymeric hydrogel particle (e.g., after the UV light exposure and removal of unattached functional material 22). In still other examples, the functional material 22 is the functionalized particle, and the polymeric hydrogel coating is pre-grafted with the primer set 24. In some of these examples, e.g., in which the functional material 22 is the functionalized particle pre-grafted with the primer set 24, the functionalized particle may be pre-clustered.

When the polymeric hydrogel or the functionalized particles are not pre-grafted, grafting is performed in the flow cell 10′ by introducing the primer solution or mixture as described herein into the flow channel 11 so that it fills the depressions 18 containing the attached functional material 22′. The primers 26, 28 are allowed to react with reactive groups of the polymeric hydrogel or the polymeric hydrogel particle or the polymeric hydrogel coating, thereby forming a chemical bond and attaching the primers 26, 28 to the attached functional material 22′. Unreacted primer solution or mixture may then be removed, and the flow cell 10′ is ready for sequencing.

Method of Forming a Flow Cell Having Passivated and/or Functionalized Interstitial Regions

The method in FIG. 4A through FIG. 4E generally includes depositing a first functional material 22 over a resin layer 16 including depressions 18 separated by interstitial regions 20, wherein: the resin layer 16 includes an ultraviolet (UV) light blocking additive 30; the depressions 18 overlie a first portion of the resin layer 16 having a first thickness T₁ and the interstitial regions 20 overlie a second portion of the resin layer 16 having a second thickness T₂ that is greater than the first thickness T₁; and the first functional material 22 is susceptible to interaction with the resin layer 16 when exposed to UV light; directing, through the resin layer 16, a first predetermined UV light dosage D₁, whereby the first functional material 22 within the depressions 18 is exposed to the first predetermined UV light dosage D₁ and attaches to the resin layer 16 within the depressions 18, and the first functional material 22 overlying the interstitial regions 20 is blocked from being exposed to the first predetermined UV light dosage D₁ by the second resin portion and remains unattached to the resin layer 16 at the interstitial regions 20; removing the first functional material 22 from the interstitial regions 20; depositing a second material 32 over the interstitial regions 20 and over the first functional material 22 in the depressions 18 (i.e., attached first functional material 22′), wherein the second material 32 is susceptible to interaction with the resin layer 16 when exposed to UV light and is not susceptible to interaction with the first functional material 22 (i.e., attached first functional material 22′) when exposed to UV light; and directing a second predetermined UV light dosage D₂ directly at the second material 32, whereby the second material 32 is exposed to the second predetermined UV light dosage D₂ and attaches to the resin layer 16 at the interstitial regions 20 and remains unattached to the first functional material 22 (i.e., attached first functional material 22′).

As shown in FIG. 4A through FIG. 4E, the patterned substrate includes a base support 16 and a resin layer 16 applied directly thereon. The base support 14 may include any of the base support 14 materials set forth herein.

The resin layer 16 may be any of the resin materials disclosed herein, and the resin may be deposited, patterned, and cured using any suitable method described herein. These processes generate the patterned structure where the resin layer 16 includes regions with desirable thicknesses T₁, T₂. More specifically, the portion of the resin layer 16 overlying the depression 18 has the first thickness T₁, and portions of the resin layer 16 overlying the interstitial regions 20 have the second thickness T₂ that is greater than the first thickness T₁.

As shown in FIG. 4A, a depression 18 is defined in the resin layer 16, the depression 18 being directly adjacent to interstitial regions 20. While a single depression 18 is shown in FIG. 4A through FIG. 4E, it is to be understood that the patterned structure may include a plurality of depressions 18, where each individual depression 18 is separated from each other depression 18 by interstitial regions 20 (similar to that shown in FIG. 1B and FIG. 1C).

With the depression 18 formed in the resin layer 16, this example method continues with the application of a first functional material 22 over the depression 18 and over the interstitial regions 20. This is shown in FIG. 4A. As described, the first functional material 22 is susceptible to interaction with (e.g., attachment to) the resin layer 16 when in contact therewith and upon exposure to the first predetermined UV light dosage D₁.

In the example shown in FIG. 4A through FIG. 4E, the first functional material 22 is a polymeric hydrogel that attaches to the resin layer 16 within the depressions 18 when exposed to the first predetermined UV light dosage D₁. In this example, the polymeric hydrogel may be any of the polymeric hydrogel materials disclosed herein.

In another example, the first functional material 22 is the polymeric hydrogel particle or the polymeric hydrogel that is coated on the core particle and that attaches to the resin layer 16 within the depressions 18 when exposed to the first predetermined UV light dosage D₁. In other words, in this example, the first functional material 22 is an example of the functionalized particle. The functionalized particle may be pre-clustered or non-pre-clustered. In this example, the polymeric hydrogel may be any of the polymeric hydrogel materials disclosed herein, and the core particle (when used) may be any of the core particle materials disclosed herein.

In still another example, the first functional material 22 includes a primer set 24 (including primers 26, 28) that attaches to the resin layer 16 within the depressions 18 when exposed to the first predetermined UV light dosage D₁. In this example, the flow cell 10, 10′ may be free of any polymeric hydrogel(s). The primer set 24 (including primers 26, 28) may include any of the oligonucleotide primers disclosed herein, provided that the primers 26, 28 have orthogonal cleaving groups to separately generate forward and reverse strands.

As shown in FIG. 4B, following the application of the first functional material 22 over the resin layer 16 (e.g., over the depressions 18 and over the interstitial region(s) 20), this example method continues by directing the first predetermined UV light dosage D₁ through a bottom of the resin layer 16 (represented by the arrows in FIG. 4B) to form an attached first functional material 22′ within the depression 18. During this process, the first functional material 22 within the depression 18 is exposed to the predetermined UV light dosage D₁, which initiates a UV-triggered reaction and attaches the first functional material 22 to a surface of the resin layer 16 within the depression 18. As described herein, this exposure may be facilitated by the first (thinner) thickness T₁ of the portion of the resin layer 16 underlying the depression 18, which is capable of UV light transmission, and may not be inhibited by the amount of the UV light blocking additive 30 present at this portion. The UV exposure forms the attached first functional material 22′ within the depression 18.

It is to be understood, however, that during this process, the first functional material 22 over the interstitial regions 20 will not be exposed to sufficient UV light to trigger a chemical reaction at the interstitial regions 20, and thus the first functional material 22 will not attach to portion(s) of the resin layer 16 that form/underlie the interstitial regions 20. In the same manner as described herein, the blockage of the first predetermined UV light dosage D₁ at the interstitial regions 20 may be facilitated by the second (thicker) thickness T₂ of the portions of the resin layer 16 that form/underlie the interstitial regions 20, and the amount of the UV light blocking additive 30 present at these portions.

When the first functional material 22 is the polymeric hydrogel, exposure of the first functional material 22 within the depression 18 to the first predetermined UV light dosage D₁ triggers a chemical reaction between the UV reactive functional groups of the first functional material 22 and the resin layer 16. This forms one example of the attached first functional material 22′ at the bottom of the depression 18.

When the first functional material 22 is the functionalized particle (either pre-clustered or non-pre-clustered), exposure of the first functional material 22 within the depression 18 to the first predetermined UV light dosage D₁ triggers a chemical reaction between the UV reactive functional groups of the first functional material 22 and the resin layer 16. This forms another example of the attached first functional material 22′ at the bottom of the depression 18.

In some examples, the first functional material 22 is the primer set 24. In these examples, exposure of the first functional material 22 to the predetermined UV light dosage D₁ triggers a chemical reaction that attaches the 5′ end functional group of each primer 26, 28 (of the primer set 24) to respective UV reactive functional groups of the resin layer 16 at the bottom of the depression 18.

The exposure of any example of the first functional material 22 to the predetermined UV light dosage D₁ can initiate a variety of chemical reactions within the depressions 18, depending in part upon the material used for the first functional material 22 and/or on a desired point of attachment for the first functional material 22. As examples, exposure of the first functional material 22 to the predetermined UV light dosage D₁ can be used to initiate: a thiol-ene or thiol-yne cycloaddition reaction, a hetero-Diels-Alder reaction, a sydnone-alkene or alkyne cycloaddition reaction, an azirine-alkene cycloaddition reaction, oxime ligation, and others.

As shown in FIG. 4C, following the exposure of the first functional material 22 to the predetermined UV light dosage D₁ and the formation of attached first functional material 22′ within the depression 18, the method continues with the removal of the (unattached) first functional material 22 from the interstitial regions 20. The unattached first functional material 22 may be removed from the resin layer 16 using any suitable method described herein in reference to FIG. 2D. In an example, a washing solution (e.g., buffer) is used to rinse the patterned structure.

As shown in FIG. 4D, following the removal of unattached first functional material 22 from the interstitial regions 20 of the structure of FIG. 4C, this example method continues with the application of a second material 32 over the interstitial regions 20 and over the attached first functional material 22′ within the depression 18. Any suitable deposition technique described herein may be used to deposit the second material 32. It is to be understood, however, that the deposition technique used will depend, in part, upon the material used for the second material 32.

In some examples, the second material 32 is a passivating material. As described herein, the passivating material may be a material that is capable of preventing the attachment of moieties (e.g., primers, etc.) at the interstitial regions 20. The passivating material may prevent a dye or a protein from attaching to the interstitial regions 20, e.g., during use of the flow cell 10, 10′. In some of these examples, the passivating second material 32 is one of the hydrogel or resin materials disclosed herein that includes a UV reactive functional group. In these examples, the passivating second material 32 is capable of attaching to portions of the resin layer 16 that form the interstitial regions 20 upon exposure to the second predetermined UV light dosage D₂.

In other examples, the second material 32 is a functionalizing material. As described, the functionalizing material may be a material that is capable of improving a SNR (signal-to-noise ratio) during sequencing operations, thereby improving the performance of the flow cell. In an example, the second material 32 is a functionalizing material that is selected from the group consisting of a quencher, an anti-oxidant, and a combination thereof. The dark quencher (when used) may absorb energy at the interstitial regions and dissipate the energy as heat to improve a signal-to-noise ratio during sequencing. The anti-oxidant (when used) may reduce damage done to DNA being sequenced during sequencing operations. As mentioned above, these examples of the functionalizing material may be attached through a polymer layer, such as PNIPPAm. In these examples, the quencher and/or anti-oxidant may first be attached to the polymer layer, and then the UV exposure D₂ may be used to attach the polymer layer to the interstitial regions 20.

In examples where the attached functional material 22′ is the polymeric hydrogel (in the form of a layer, particle, or particle coating), the functionalizing second material 32 may be a polymeric hydrogel that is capable of grafting one of the primer sets 24A or 24B or 24A′ or 24B′ thereto and that is capable of attaching to the resin layer 16 at the interstitial regions 20 upon exposure to the second predetermined UV light dosage D₂. The second polymeric hydrogel may be any of the hydrogel materials described herein, as long as the hydrogel includes a UV reactive functional group that is capable of attaching to the resin layer 16 that forms the interstitial regions 20 upon exposure to the second predetermined UV light dosage D₂, and as long as the hydrogel is capable of grafting one of the primer sets 24A or 24B or 24A′ or 24B′ thereto. In these examples, the second functionalizing material 32 may have the primer set 24A or 24B or 24A′ or 24B′ pre-grafted thereto. In this particular example, it is to be understood that the other of the primer sets 24B or 24A or 24B′ or 24A′ is attached to the attached functional material 22′ (either via grafting after hydrogel attachment within the depression 18 or as pre-grafted primers).

As shown in FIG. 4E, following the application of any example of the second material 32 over the interstitial regions 20 and over the attached first functional material 22′ within the depression 18, this example method continues by directly exposing the second material 32 to the second predetermined UV light dosage D₂. Exposure of the second material 32 to the second predetermined UV light dosage D₂ initiates a chemical reaction that attaches the second material 32 to the resin layer 16 that forms/underlies the interstitial regions 20 (thereby forming attached second material 32′ at the interstitial regions 20). It is to be understood, however, that the second material 32 is not susceptible to interaction with the attached first functional material 22′ when exposed to the second predetermined UV light dosage D₂. As such, the second material 32 within the depression 18 (e.g., positioned over the attached first functional material 22′) will remain unattached to the attached first functional material 22′ during and after the exposure to the second predetermined UV light dosage D₂. The unattached second material 32 can be removed from the attached first functional material 22′ using any suitable method (e.g., sonication, washing, etc.).

It is to be understood that a small fraction of the second material 32 may attach to exposed portions of the resin layer 16 within the depression(s) 18 (e.g., along the sidewalls), and that this will depend, at least in part, upon quality of the first reaction (i.e., the formation of the attached first functional material 22′).

When the second material 32 is the quencher and/or anti-oxidant, the polymer layer is used to attach these materials to the interstitial regions 20. Thus, the second predetermined UV light dosage D₂ triggers a chemical reaction between the UV reactive functional groups of the polymer layer and the resin layer 16.

When the second material 32 is the polymeric hydrogel (that is not pre-grafted with a primer set 24A or 24B or 24A′ or 24B′), exposure of the second material 32 over the interstitial regions 20 to the second predetermined UV light dosage D₂ triggers a chemical reaction between the respective UV reactive functional groups of the polymeric hydrogel of the second material 32 and of the resin layer 16. This forms one example of the attached second material 32′ at the interstitial regions 20. The polymeric hydrogel of the second material 32 will not react with the polymeric hydrogel already present in the depression 18 (i.e., attached functional layer 22′). In some instances, the polymeric hydrogel of the second material 32 is deposited under high ionic strength (e.g., in the presence of 10×PBS, NaCl, KCl, etc.), which aids the second material 32 selectively attaching to the interstitial regions 20. In these instances, the high ionic strength conditions keep the second polymeric hydrogel (of the second material 32) from depositing on or adhering to the attached functional layer 22′. Thus, unreacted polymeric hydrogel of the second material 32 may be removed before primer grafting takes place. It is to be understood that in this example, the polymeric hydrogel of the second material 32 is chemically different than the polymeric hydrogel of the first functional material 22 (e.g., to facilitate selective attachment of primer sets 24A or 24B or 24A′ or 24B′ at depressions 18 or interstitial regions 20). In this example, the primer set 24A or 24B or 24A′ or 24B′ is then grafted to the polymeric hydrogel of the attached second material 32′. Because the primer set 24A or 24B or 24A′ or 24B′ is selective to the chemistry of the polymeric hydrogel of the attached second material 32′, grafting may be performed using any of the techniques described herein. The primer set 24A or 24B or 24A′ or 24B′ grafted to the polymeric hydrogel of the attached second material 32′ will not attach to the polymeric hydrogel of the functional layer 22′. In this example, it is to be understood that one of the primer sets 24A or 24A′ is grafted to the attached functional material 22′ and the other of the primer sets 24B or 24B′ is grafted to the attached second material 32′ in order to enable simultaneously paired end sequencing.

When the second material 32 is the pre-grafted polymeric hydrogel (which is pre-grafted with a primer set 24A or 24B or 24A′ or 24B′), exposure of the second material 32 over the interstitial regions 20 to the second predetermined UV light dosage D₂ triggers a chemical reaction between the respective UV reactive functional groups of the pre-grafted polymeric hydrogel of the second material 32 and of the resin layer 16. This process may be performed under the high ionic strength conditions described herein. This forms one example of the attached second material 32′ at the interstitial regions 20. As noted above, the polymeric hydrogel of the second material 32 will not react with the polymeric hydrogel already present in the depression 18. Thus, unreacted pre-grafted polymeric hydrogel of the second material 32 may be removed. It is to be understood that in this example, the polymeric hydrogel of the second material 32 may or may not be chemically different than the polymeric hydrogel of the first functional material 22 because the primer set is pre-grafted to the polymeric hydrogel of the second material 32 and additional primer is not performed. In this example, it is to be understood that one of the primer sets 24A or 24A′ is grafted to the attached functional material 22′ and the other of the primer sets 24B or 24B′ is pre-grafted to the attached second material 32′ in order to enable simultaneously paired end sequencing.

The exposure of any example of the second material 32 to the predetermined UV light dosage D₂ can initiate a variety of chemical reactions at the interstitial regions 20, depending in part upon the material used for the second material 32 and/or on a desired point of attachment for the second material 32. As examples, exposure of the second material to the predetermined UV light dosage D₂ can be used to initiate: a thiol-ene or thiol-yne cycloaddition reaction, a hetero-Diels-Alder reaction, a sydnone-alkene or alkyne cycloaddition reaction, an azirine-alkene cycloaddition reaction, oxime ligation, and others.

While not shown in FIG. 4A through FIG. 4E, in examples of the method where the attached first functional material 22′ is the polymeric hydrogel, the method may further include grafting the primer set 24 (including primers 26, 28) to the attached polymeric hydrogel (e.g., after the first UV light exposure and removal of unattached first functional material 22). In other examples, the first functional material 22 is the polymeric hydrogel, and the polymeric hydrogel is pre-grafted with the primer set 24.

Further, while not shown in FIG. 4A through FIG. 4E, in examples of the method where the first functional material 22 is the polymeric hydrogel particle or the polymeric hydrogel that is coated on the core particle and that attaches to the resin layer 16 within the depression 18 when exposed to the first predetermined UV light dosage D₁ (i.e., is the functionalized particle), the method may further include grafting the primer set 24 (including primers 26, 28) to the attached first functional material 22′ (e.g., after the first UV light exposure and removal of unattached first functional material 22). In other examples where the first functional material 22 is the functionalized particle, the method further includes pre-grafting the primer set 24 (including primers 26, 28) to the material 22.

Grafting of the primer set 24 to the polymeric hydrogel, the polymeric hydrogel coating, or the polymeric hydrogel coating (of the attached first functional material 22′) may be performed as described herein in reference to FIG. 2D. With any of the grafting methods, the primers 26, 28 react with reactive groups of the polymeric hydrogel and form a chemical bond, thereby attaching the primers 26, 28 to the polymeric hydrogel.

The patterned structure that is formed using the method of FIG. 4A through FIG. 4E may be attached to a lid or another patterned structure to form the flow cell 10, 10′. Bonding may take place before or after primer grafting. When bonding is performed before primer grafting, it is to be understood that primer grafting may be performed using a flow through technique. When two patterned structures formed using the method of FIG. 4A through FIG. 4E are bonded together before primer grafting, the respective surfaces may be grafted simultaneously using the flow through technique.

The patterned structure and the lid or the second patterned structure may be bonded using any suitable technique, such as laser bonding, diffusion bonding, anodic bonding, eutectic bonding, plasma activation bonding, glass frit bonding, or others methods known in the art. In these examples, it is to be understood that the bonding regions 38 are free of the second material 32′. These regions 38 may be masked or otherwise not exposed to the second predetermined light dosage D₂ so that they remain available for bonding.

In any of the examples disclosed herein where the primer set 24 or the primer sets 24A, 24B or 24A′, 24B′ are directly attached to the resin layer 16, it is to be understood that the UV dosage, intensity, exposure time, or the like may be adjusted to minimize or prevent damage to the primers.

When the primer sets 24A, 24B or 24A′, 24B′ are used, the respective sets 24A, 24B or 24A′, 24B′ may be grafted sequentially in predetermined regions so that one set 24A, 24A′ is attached at one region of the attached functional material 22′ and the other set 24B, 24B′ is attached at another region of the attached functional material 22′. Selective grafting may be performed by masking a portion of the attached functional material 22′ (that is not to graft a particular set 24A, 24A′ or 24B, 24B′) during the grafting of that particular set 24A, 24A′ or 24B, 24B′. Alternatively, different pre-grafted functional materials 22 (i.e., functional materials respective grafted with the desired set 24A, 24A′ or 24B, 24B′) could be used and selective UV exposure could be used to attach the pre-grafted functional materials 22 in respective portions of the depressions 18.

### NON-LIMITING WORKING EXAMPLES

### Example 1

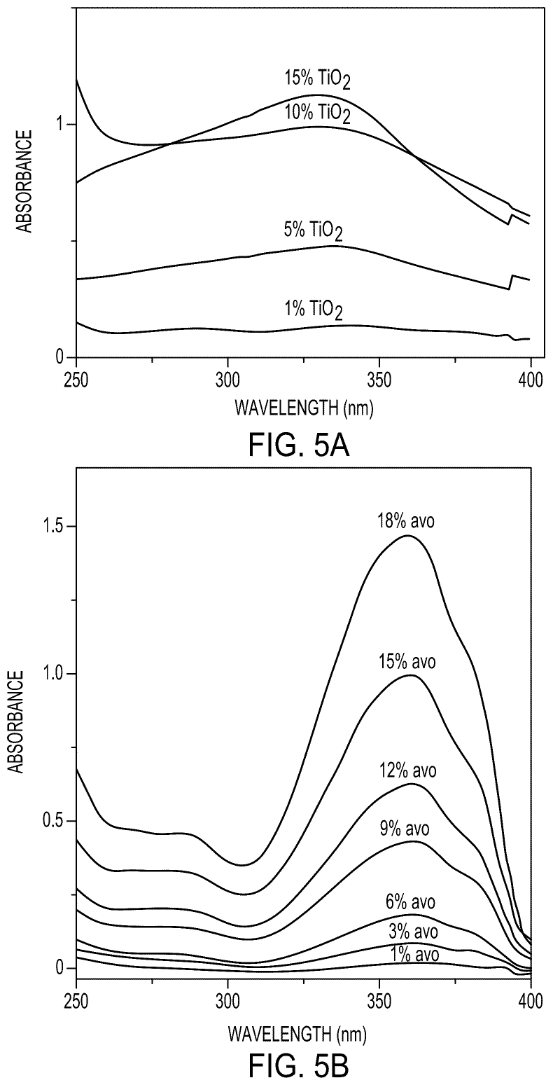

One of the methods described in reference to FIG. 2A through FIG. 2D was used in this example. Titanium dioxide (TiO₂) doped acrylate resins were used as examples of a resin layer including different amounts of inorganic UV light blocking additive particles ranging from 1 wt % to 15 wt %, and avobenzone-doped acrylate resins were used as examples of a resin layer including different amounts of organic UV light blocking additive particles ranging from 1 wt % to 18 wt %. Each resin composition was deposited, cured, and patterned (using nanoimprint lithography) to form depressions separated by interstitial regions. A predetermined UV light dosage was directed through each resin layer. The amount of UV light being transmitted through each resin layer was measured using a UV-VIS spectrophotometer. The UV absorbance exhibited by each of the titanium dioxide doped acrylate resins is depicted in FIG. 5A, and the UV absorbance exhibited by each of the avobenzone-doped acrylate resins is shown in FIG. 5B. In FIG. 5A and FIG. 5B, the absorbance (of UV light, arbitrary units) for each resin (which are identified by the wt % of the respective UV light blocking additive particles) is shown on the Y axis, and wavelength of light in nanometers is shown on the X axis.

As can be seen in FIG. 5A, including increasing amounts of UV-blocking titanium dioxide particles in the titanium dioxide doped acrylate resin composition resulted in increased absorbance of UV light by the resin layer (and therefore better UV light blockage). Similarly, as can be seen in FIG. 5B, including increasing amounts of UV-blocking avobenzone in the resin composition resulted in increased absorbance of UV light by the resin layer (and therefore better UV light blockage). As such, these examples support that the content of UV-blocking additive particles included within the resin layer affects the resin layer's ability to block (e.g., absorb and/or reflect) or transmit UV light.

### Example 2

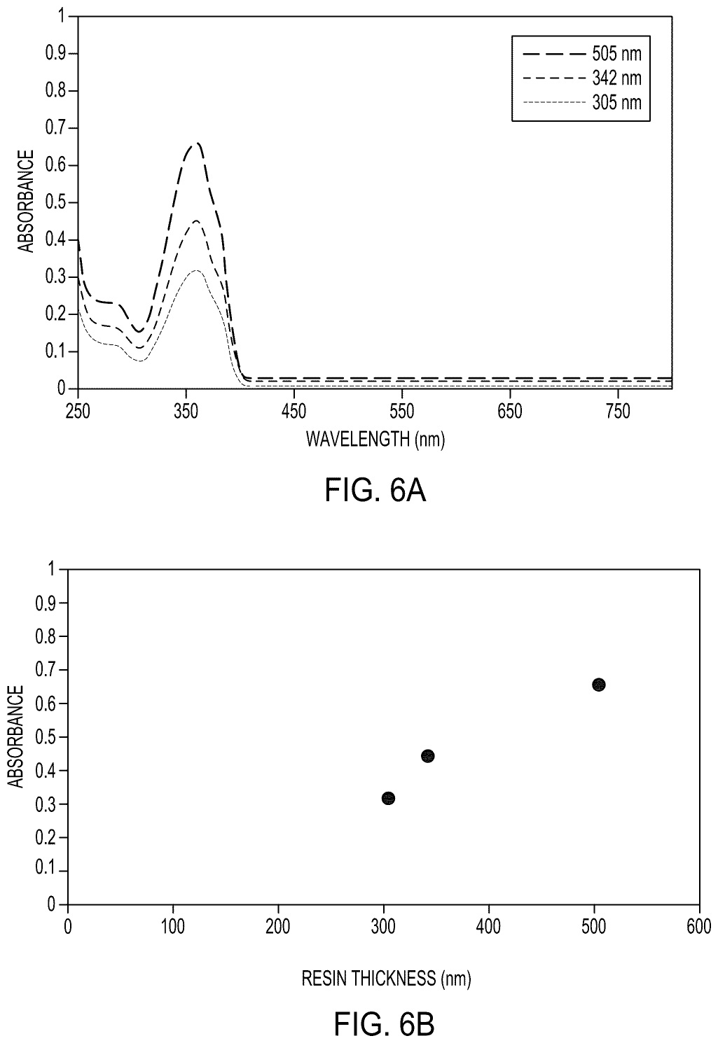

One of the methods described in reference to FIG. 2A through FIG. 2D was used in this example. In this example, the resin composition included 20 wt % (of total resin composition weight) pentaerythritol triacrylate (PE3A) and 2 wt % (of total resin composition weight) phenylbis(2,4,6-trimethylbenzoyl) phosphine oxide (DPBAPO) in a solvent (balance of total resin composition weight), doped with 18 wt % (of total resin composition weight) avobenzone (an example of the UV light blocking additive), which included 120 wt % (of total avobenzone weight) of DISPERBYK-168@. The resin was spin-coated three different times to produce respective films having a thickness of 505 nm, a thickness of 342 nm, and a thickness of 305 nm. A predetermined UV light dosage was directed through each of the resin layers. The amount of UV light being absorbed by the resin composition was measured using a UV-VIS spectrophotometer, and the thicknesses of each resin layer was measured using ellipsometry (i.e., using a COMPLETEEASE™ RC2 Ellipsometer, available from J.A. Woollam Co., Inc.). The results for the absorption of UV light by each individual resin layer are depicted in FIG. 6A and in FIG. 6B.

As can be seen, the resin composition having the thickest film (e.g., 505 nm) displayed the greatest degree of absorption of the UV light (about 0.65). In contrast, the resin composition having the thinnest film (e.g., 305 nm) displayed the lowest degree of absorption of the UV light (about 0.3). These results demonstrate that increasing the thickness of the resin layer(s) described herein may result in increased absorbance of UV light by the resin layer(s).

### Additional Notes

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

While several examples have been described in detail, it is to be understood that the disclosed examples may be modified. Therefore, the foregoing description is to be considered non-limiting.

What is claimed is:

1. A method, comprising:
depositing a functional material over a resin layer including depressions separated by interstitial regions, wherein:
the resin layer includes an ultraviolet (UV) light blocking additive;
the depressions overlie a first portion of the resin layer having a first thickness and the interstitial regions overlie a second portion of the resin layer having a second thickness that is greater than the first thickness; and
the functional material is susceptible to interaction with the resin layer when exposed to UV light; and
directing, through the resin layer, a predetermined UV light dosage, whereby the functional material within the depressions is exposed to the predetermined UV light dosage and attaches to the resin layer within the depressions, and the functional material overlying the interstitial regions is blocked from being exposed to the predetermined UV light dosage by the second resin portion.

2. The method as defined in claim 1, wherein the functional material is a polymeric hydrogel that attaches to the resin layer within the depressions when exposed to the predetermined UV light dosage.

3. The method as defined in claim 2, wherein the polymeric hydrogel is pre-grafted with a primer set.

4. The method as defined in claim 2, further comprising grafting a primer set to the polymeric hydrogel.

5. The method as defined in claim 1, wherein the functional material is a polymeric hydrogel that is coated on a core particle and that attaches to the resin layer within the depressions when exposed to the predetermined UV light dosage.

6. The method as defined in claim 5, wherein after the exposure to the predetermined UV light dosage, the method further comprises attaching a primer set to the polymeric hydrogel that is coated on the core particle.

7. The method as defined in claim 1, wherein the functional material includes a primer set that attaches to the resin layer within the depressions when exposed to the predetermined UV light dosage.

8. The method as defined in claim 1, wherein the resin layer includes from about 1 wt % to about 50 wt % of the UV light blocking additive, based on a total weight of the resin layer.

9. A method, comprising:
introducing a functional material into a flow cell including two patterned substrates, each of the patterned substrates including a resin layer having depressions separated by interstitial regions, wherein:
the resin layers include an ultraviolet (UV) light blocking additive;
the depressions of each of the two patterned substrates overlie a first portion of the resin layer having a first thickness and the interstitial regions of each of the two patterned substrates overlie a second portion of the resin layer having a second thickness that is greater than the first thickness; and
the functional material is susceptible to interaction with the resin layer of each of the two patterned substrates when exposed to UV light; and
simultaneously directing, through the resin layer of each of the two patterned substrates, a predetermined UV light dosage, whereby some of the functional material within the depressions of a first of the two patterned substrates is exposed to the predetermined UV light dosage and attaches to the resin layer within the depressions of the first of the two patterned substrates, some other of the functional material within the depressions of a second of the two patterned substrates is exposed to the predetermined UV light dosage and attaches to the resin layer within the depressions of the second of the two patterned substrates, and the functional material in contact with the interstitial regions of each of the two patterned substrates is blocked from being exposed to the predetermined UV light dosage by the second resin portion.

10. The method as defined in claim 9, wherein the functional material is a polymeric hydrogel that attaches to the resin layer within the depressions of each of the first and the second of the two patterned substrates when exposed to the predetermined UV light dosage.

11. The method as defined in claim 10, wherein the polymeric hydrogel is pre-grafted with a primer set.

12. The method as defined in claim 10, further comprising grafting a primer set to the polymeric hydrogel.

13. The method as defined in claim 9, wherein the functional material is a polymeric hydrogel that is coated on a core particle and that attaches to the resin layer within the depressions of each of the first and the second of the two patterned substrates when exposed to the predetermined UV light dosage.

14. The method as defined in claim 13, wherein after the exposure to the predetermined UV light dosage, the method further comprises attaching a primer set to the polymeric hydrogel that is coated on the core particle.

15. The method as defined in claim 9, wherein the functional material includes a primer set that attaches to the resin layer within the depressions of each of the first and the second of the two patterned substrates when exposed to the predetermined UV light dosage.

16. The method as defined in claim 9, wherein the resin layer of each of the first and the second of the two patterned substrates includes from about 1 wt % to about 50 wt % of the UV light blocking additive, based on a total weight of each of the resin layers.

17. A method, comprising:
depositing a first functional material over a resin layer including depressions separated by interstitial regions, wherein:
the resin layer includes an ultraviolet (UV) light blocking additive;
the depressions overlie a first portion of the resin layer having a first thickness and the interstitial regions overlie a second portion of the resin layer having a second thickness that is greater than the first thickness; and
the first functional material is susceptible to interaction with the resin layer when exposed to UV light;
directing, through the resin layer, a first predetermined UV light dosage, whereby the first functional material within the depressions is exposed to the first predetermined UV light dosage and attaches to the resin layer within the depressions, and the first functional material overlying the interstitial regions is blocked from being exposed to the first predetermined UV light dosage by the second resin portion and remains unattached to the resin layer at the interstitial regions;
removing the first functional material from the interstitial regions;
depositing a second material over the interstitial regions and over the first functional material in the depressions, wherein the second material is susceptible to interaction with the resin layer when exposed to UV light and is not susceptible to interaction with the first functional material when exposed to UV light; and
directing a second predetermined UV light dosage directly at the second material, whereby the second material is exposed to the second predetermined UV light and attaches to the resin layer at the interstitial regions and remains unattached to the first functional material.

18. The method as defined in claim 17, wherein the second material is a passivating material.

19. The method as defined in claim 17, wherein the second material is a functionalizing material that is selected from the group consisting of a quencher, an anti-oxidant, and a combination thereof.

20. The method as defined in claim 17, wherein the first functional material is a polymeric hydrogel that attaches to the resin layer within the depressions when exposed to the first predetermined UV light dosage.

21. The method as defined in claim 20, wherein the polymeric hydrogel is pre-grafted with a primer set.

22. The method as defined in claim 20, further comprising grafting a primer set to the polymeric hydrogel.

23. The method as defined in claim 17, wherein the first functional material is a polymeric hydrogel that is coated on a core particle and attaches to the resin layer within the depressions when exposed to the first predetermined UV light dosage.

24. The method as defined in claim 17, wherein the first functional material includes a primer set that attaches to the resin layer within the depressions when exposed to the first predetermined UV light dosage.

25. The method as defined in claim 17, wherein the resin layer includes from about 1 wt % to about 50 wt % of the UV light blocking additive, based on a total weight of the resin layer.


SEQUENCE LISTING (14 sequences)

SEQ ID NO: 1 - DNA, 29 bp, Synthetic construct
  source 1..29: mol_type = other DNA
  modified_base 23: mod_base = OTHER; note = uracil
aatgatacggcgaccaccgagatctacac

SEQ ID NO: 2 - DNA, 29 bp, Synthetic construct
  source 1..29: mol_type = other DNA
  modified_base 23: mod_base = i
aatgatacggcgaccaccgaganctacac

SEQ ID NO: 3 - DNA, 29 bp, Synthetic construct
  source 1..29: mol_type = other DNA
  modified_base 23: mod_base = OTHER; note = alkene-thymidine
aatgatacggcgaccaccgaganctacac

SEQ ID NO: 4 - DNA, 24 bp, Synthetic construct
  source 1..24: mol_type = other DNA
  modified_base 22: mod_base = OTHER; note = 8-oxoguanine
caagcagaagacggcatacganat

SEQ ID NO: 5 - DNA, 24 bp, Synthetic construct
  source 1..24: mol_type = other DNA
  modified_base 20: mod_base = OTHER; note = 8-oxoguanine
caagcagaagacggcatacnagat

SEQ ID NO: 6 - DNA, 24 bp, Synthetic construct
  source 1..24: mol_type = other DNA
  modified_base 22: mod_base = OTHER; note = 8-oxoguanine
  modified_base 20: mod_base = OTHER; note = 8-oxoguanine
caagcagaagacggcatacnanat

SEQ ID NO: 7 - DNA, 24 bp, Synthetic construct
  source 1..24: mol_type = other DNA
  modified_base 22: mod_base = OTHER; note = uracil
caagcagaagacggcatacgatat

SEQ ID NO: 8 - DNA, 24 bp, Synthetic construct
  source 1..24: mol_type = other DNA
  modified_base 20: mod_base = OTHER; note = uracil
caagcagaagacggcatactagat

SEQ ID NO: 9 - DNA, 29 bp, Synthetic construct
  source 1..29: mol_type = other DNA
  modified_base 23: mod_base = OTHER; note = allyl-T
aatgatacggcgaccaccgaganctacac

SEQ ID NO: 10 - DNA, 35 bp, Synthetic construct
  source 1..35: mol_type = other DNA
gctggcacgtccgaacgcttcgttaatccgttgag

SEQ ID NO: 11 - DNA, 35 bp, Synthetic construct
  source 1..35: mol_type = other DNA
cgtcgtctgccatggcgcttcggtggatatgaact

SEQ ID NO: 12 - DNA, 35 bp, Synthetic construct
  source 1..35: mol_type = other DNA
acggccgctaatatcaacgcgtcgaatccgcaact

SEQ ID NO: 13 - DNA, 34 bp, Synthetic construct
  source 1..34: mol_type = other DNA
gccgcgttacgttagccggactattcgatgcagc

SEQ ID NO: 14 - DNA, 24 bp, synthetic construct
  source 1..24: mol_type = other DNA
aggaggaggaggaggaggaggagg